(19) United States
(12) Patent Application Publication
(10) Pub. No.: US 2026/0084609 A1
(43) Pub. Date: Mar. 26, 2026

(54) Cabinetry and Dinettes for Recreational Vehicles

(71) Applicant: Thor Tech, Inc., Elkhart, IN (US)

(72) Inventors: Trent Tobolski, Granger, IN (US); Steve Romanowski, Albion, IN (US); Vishnu Ramkumar, Kalamazoo, MI (US)

(73) Assignee: Thor Tech, Inc., Elkhart, IN (US)

(21) Appl. No.: 19/332,432

(22) Filed: Sep. 18, 2025

Related U.S. Application Data
(60) Provisional application No. 63/697,240, filed on Sep. 20, 2024.

(51) Int. Cl. B60P 3/39; A47B 77/02

(52) U.S. Cl. CPC B60P 3/39; A47B 77/02

(57) ABSTRACT

A recreational vehicle comprising a generally horizontal floor, a plurality of generally upstanding walls defining a living space in conjunction with the floor, and a seating element in contact with the floor and comprising a plurality of tubular supports and a plurality of generally planar side panels, and wherein: upper edges of the plurality of side panels comprise a first ledge adjacent a front edge and a second ledge proximal a rear edge, the ledges being closer to a lower edge than a remainder of the upper edge is to the lower edge, each of tubular supports extends from a ledge of one side panel to a corresponding ledge of another side panel, and an upper surface of the tubular supports positioned in the ledges is coplanar with the remainder of the upper edge.

### CROSS REFERENCE TO RELATED APPLICATIONS

This application claims the benefit of U.S. Provisional Application Ser. No. 63/697,240 (THOR0061MA), filed Sep. 20, 2024, which is hereby incorporated by reference.

### TECHNICAL FIELD

Embodiments of the present disclosure generally relate to fixtures for recreational vehicles, and particularly to dinettes and cabinetry for recreational vehicles.

### BACKGROUND

Recreational vehicles (RVs) take a variety of forms (pull-type trailer, self-propelled, etc.) and are manufactured using different manufacturing methods. The chassis' of such recreational vehicles may often be pre-fabricated prior to filling out the inside with fixtures associated with kitchens, dining rooms, living rooms, bathrooms, and other amenities. Accordingly, cabinetry, dinettes, and other amenities desired to be fitted into the recreational vehicles may be size constrained by the entrances to the recreational vehicle itself.

Moreover, as the size of recreational vehicles can vary greatly, it may be desired to transport the individual parts of the fixtures into the recreational vehicle separately. Furthermore, consumers' wants in terms of amenities may vary, such that it may be desired that the components of the cabinetry, dinettes, and other amenities be useable for a variety of configurations. Further yet, consumers' wants may vary over time, such that it may be desired that the cabinetry, dinettes, and other amenities (such as but not limited to height, width, depth, etc.) may be adjustable per the consumer's changing needs. Finally, fixtures may break over time, resulting in a need to replace fixtures with alternative fixtures. Accordingly, it may be desired that the fixtures be adjustable even after being initially installed.

### SUMMARY

Without being limited by theory, the common side panel system elaborated on herein may permit an easier method of assembly, with a reduced complexity driven by thoughtful engineering principles that allow for weight reduction, unique and total piece count reductions, along with an increase in product quality. Product quality is driven through finite element analysis (FEA) to meet or exceed residential cabinetry standards by understand component and assembly strengths. The system allows for an assembly method where an operator (or even consumer) can snap and screw/staple the assembly together akin to a block-based toy or assembly furniture.

Although the concepts of the present disclosure are described herein with primary reference to fixtures for recreational vehicles, it is contemplated that the concepts will enjoy applicability to any fixtures, such as any dinettes or cabinetry. For example, and not by way of limitation, it is contemplated that the concepts of the present disclosure will enjoy applicability to dinettes and cabinetry for commercial, workplace, and domestic settings.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a RV, and in particular a vehicle shell/body for the RV, according to embodiments herein;

FIG. 2A illustrates an exemplary view of a living space for an RV or otherwise, including a dinette, kitchen cabinetry, overhead cabinetry, medicine cabinet, and bathroom cabinetry, according to embodiments herein;

FIG. 2B illustrates the living space of FIG. 2A with one or more cosmetic panels removed to show the internal frame structure and side panels, according to embodiments herein;

FIG. 3A illustrates a closer view of the overhead cabinetry of FIG. 2A, according to embodiments herein;

FIG. 3B illustrates the overhead cabinetry of FIG. 3A, with one or more cosmetic panels removed to show the internal frame structure and side panels, according to embodiments herein;

FIG. 3C illustrates the overhead cabinetry of FIGS. 3A-3B, with one or more shelves and one or more aperture reinforcements additionally removed to further show the internal frame structure and side panels, according to embodiments herein;

FIG. 3D illustrates a section of the overhead cabinetry of FIG. 3C, particularly illustrating a bridge section of the cabinetry to accommodate an underlying sink, stove top, or other wall-mounted fixture, as well as a fastener mounted to and dismounted from an aperture reinforcement, according to embodiments herein;

FIG. 3E illustrates one version of the side panel of the overhead cabinetry of FIG. 3F, according to embodiments herein;

FIG. 3F illustrates another version of the side panel of the overhead cabinetry of FIGS. 3A-3E, according to embodiments herein;

FIG. 3G illustrates another view of the side panel of FIG. 3F, according to embodiments herein;

FIG. 3H illustrates yet another version of the side panel of the overhead cabinetry of FIGS. 3A-3D, according to embodiments herein;

FIG. 3I illustrates another view of the side panel of FIG. 3H, according to embodiments herein;

FIG. 4A illustrates a front view of an aperture reinforcement and an associated fastener for mounting thereon, such as for mounting another component to the one or more side-panels herein, according to embodiments herein;

FIG. 4B illustrates a (reverse) back view of an aperture reinforcement and an associated fastener for mounting thereon, such as for mounting another component to the one or more side-panels herein, according to embodiments herein;

FIG. 5A illustrates a spacer for the cabinet structure according to embodiments herein, arranged in a primary orientation for a smaller bottom shelf internal spacing;

FIG. 5B illustrates the spacer of FIG. 5A for the cabinet structure according to embodiments herein, arranged in a secondary orientation for a greater bottom shelf internal spacing;

FIG. 6A illustrates a closer view of one of the seating elements of the dinette of FIGS. 2A-2B, according to embodiments herein;

FIG. 6B illustrates a seating element of the dinette set of FIG. 6A, with one or more cosmetic panels removed to show the internal frame structure and side panels, according to embodiments herein;

FIG. 6C illustrates the seating element of FIGS. 6A-6B, with one or more additional cosmetic panels removed to further show the internal frame structure and side panels, according to embodiments herein;

FIG. 6D illustrates another view of the seating element of FIG. 6C, according to embodiments herein; and

FIG. 6E illustrates a side view of one of the ‘b-frames’ of the seating element, according to embodiments herein.

### DETAILED DESCRIPTION

Embodiments of the present disclosure generally relate to fixtures and recreational vehicles, and particularly to fixtures, such as cabinetry and dinettes, for recreational vehicles.

As used herein, the term “proximal” or “proximate” means closer to an element. The term “distal” means further from the element.

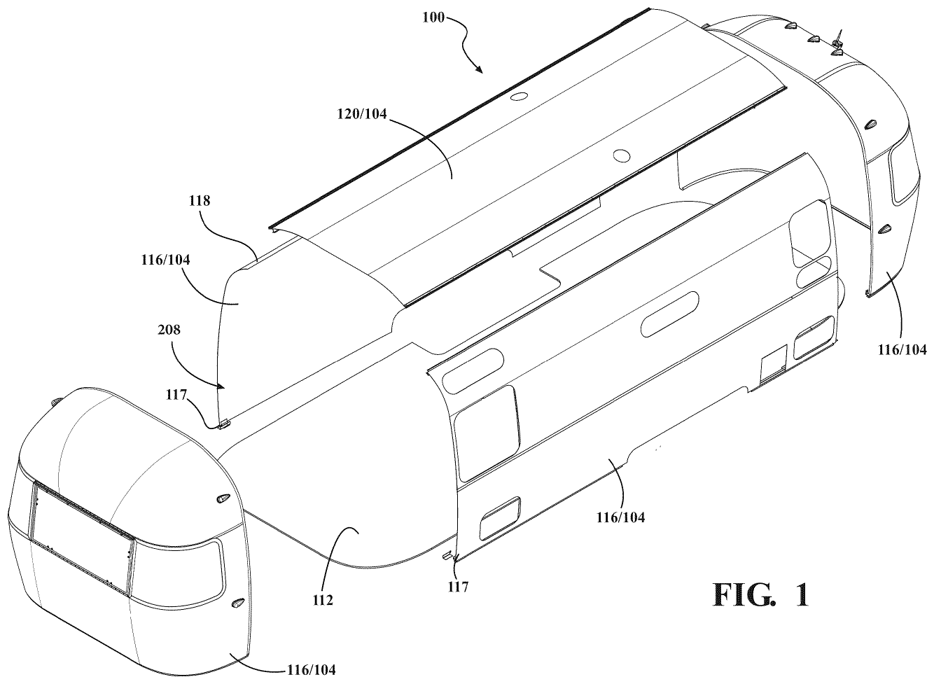

Now referring to FIG. 1, illustrated is a recreational vehicle (RV), particularly an exploded view of a recreational vehicle 100 shell/body. As shown in FIG. 1, the RV may comprise a vehicle body 104 with a generally horizontal floor 112 and a plurality of generally upstanding walls 116 that define a living space 108 (e.g., a space in which passengers may reside). While not shown, the RV may additionally comprise one or more axles and wheels to support the body and a hitch assembly for attaching to a tow vehicle. Alternatively, the RV may comprise a vehicle with a powertrain instead of being towed. The vehicle body 104 may comprise a plurality of generally upstanding walls 116 making up the living space 108, as well as a roof 120. Each of the generally upstanding walls 116 may comprise a bottom 117 adjacent the generally horizontal floor 112 and a top 118 distal to the generally horizontal floor 112, thereby defining the living space 108 in conjunction with the generally horizontal floor 112.

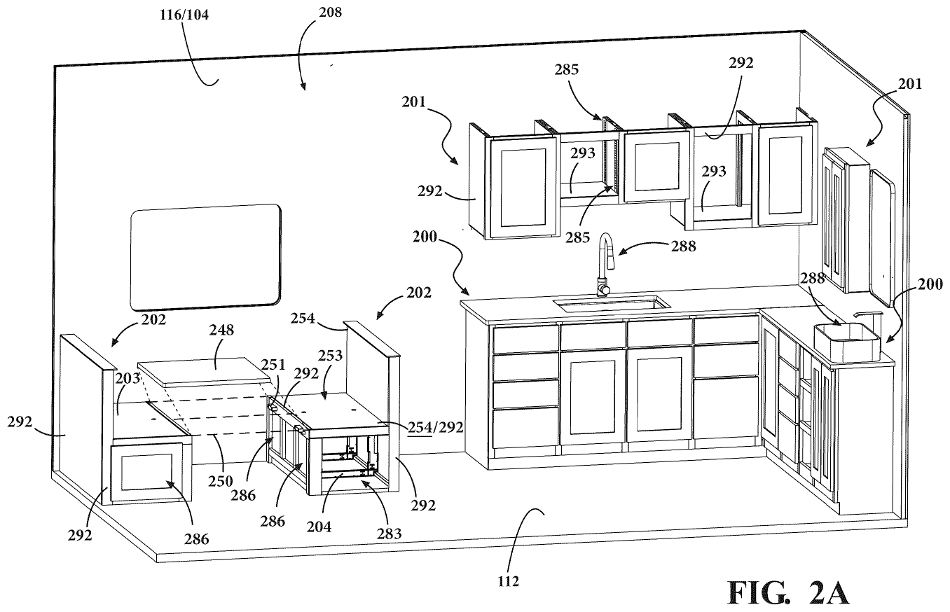

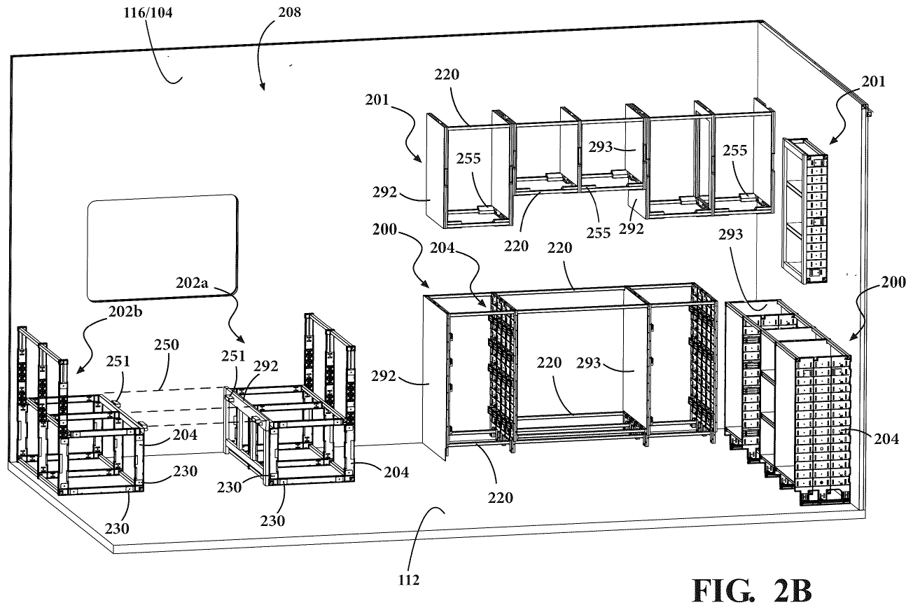

Referring now to FIGS. 2A-2B, the RV/vehicle body 104 may also comprise a lower cabinet structure 200, an upper cabinet structure 201, a dinette having at least a seating element 202, or combinations thereof. For example, and in embodiments, the lower cabinet structure 200 may be in contact with the generally horizontal floor 112 and one of the upstanding walls 116, such as in U.S. application Ser. No. 18/657,041 (THOR0026PA1) and Ser. No. 18/657,054 (THOR0026PA2), which are hereby incorporated by reference. The lower cabinet structure 200 may also incorporate one or all of the features of the upper cabinet structure 201, and vice-versa.

However, this is not meant to be limiting, and the lower cabinet structure 200 may alternatively be in contact with any of the floor 112, upstanding walls 116, or roof 120. For example, and in embodiments, the lower cabinet structure 200 may not be in contact with one of the upstanding walls 116, i.e., the lower cabinet structure 200 may be an island.

As previously stated, the vehicle body 104 may also comprise an upper cabinet structure 201. As also shown in FIGS. 2A-2B, the upper cabinet structure 201 may be in contact with one or more of the upstanding walls 116, the roof 120, or both, i.e. in at least some embodiments the upper cabinet structure 201 may not be in contact with the floor 112. In such a manner, the upper cabinet structure 201 may also be regarded as an “overhead” cabinet structure.

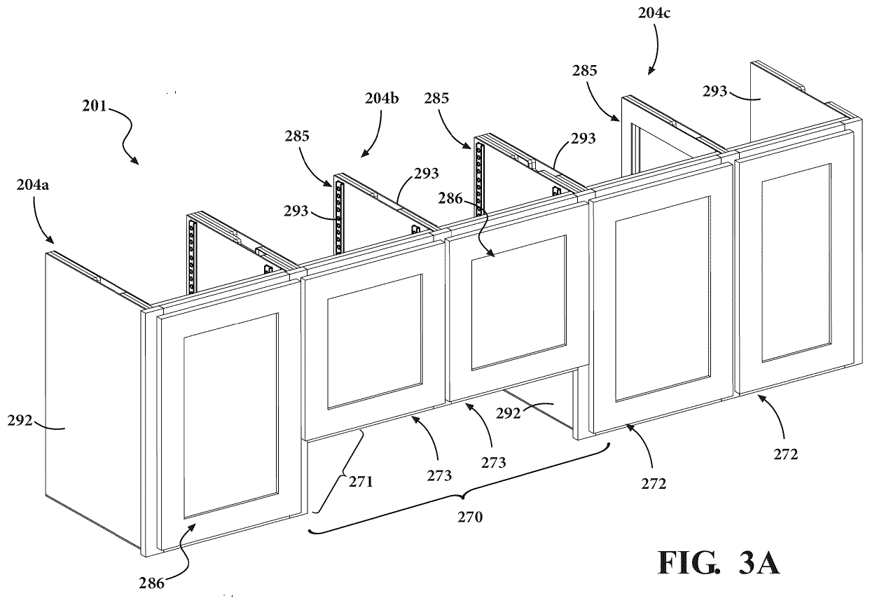

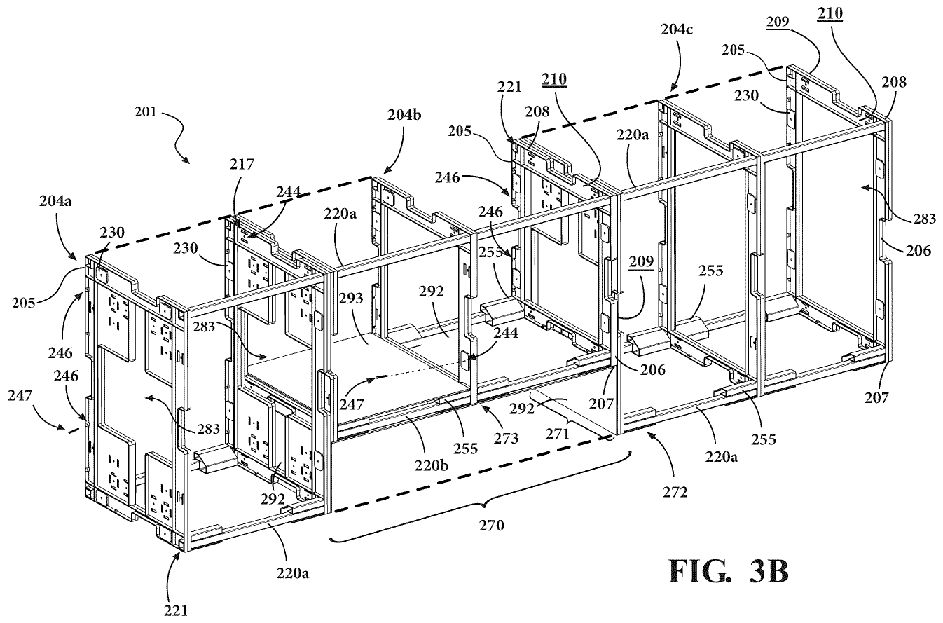

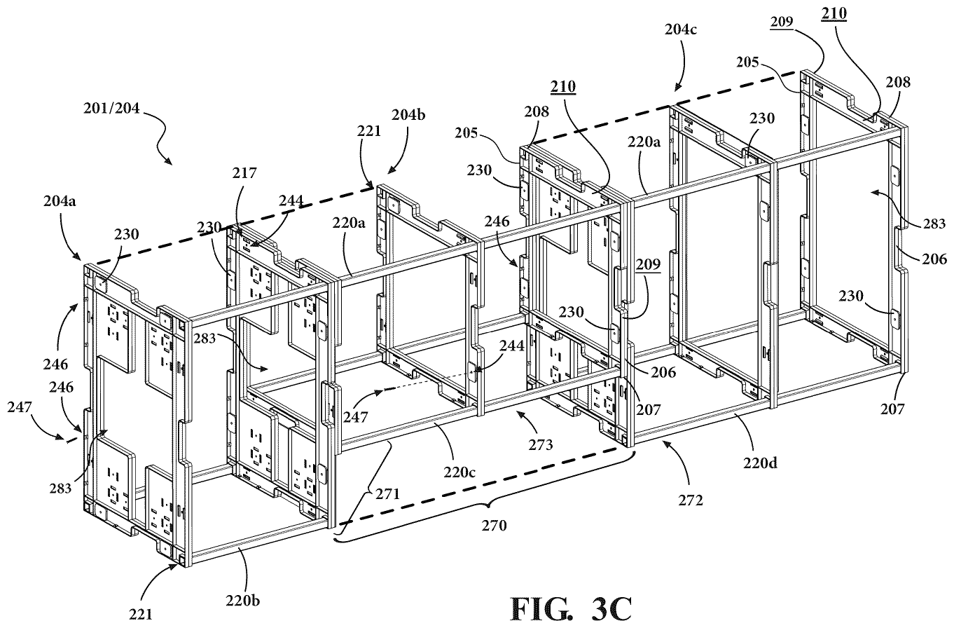

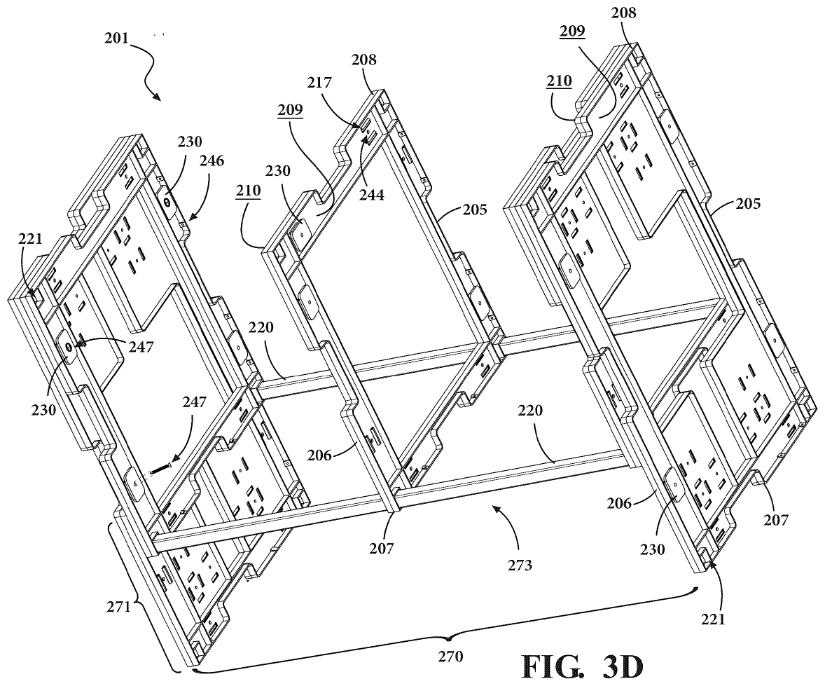

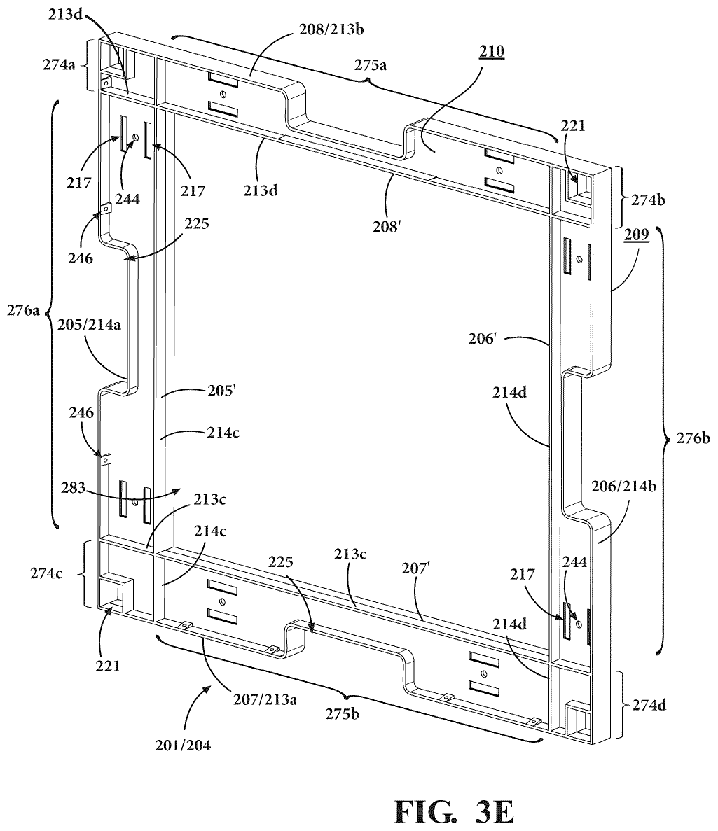

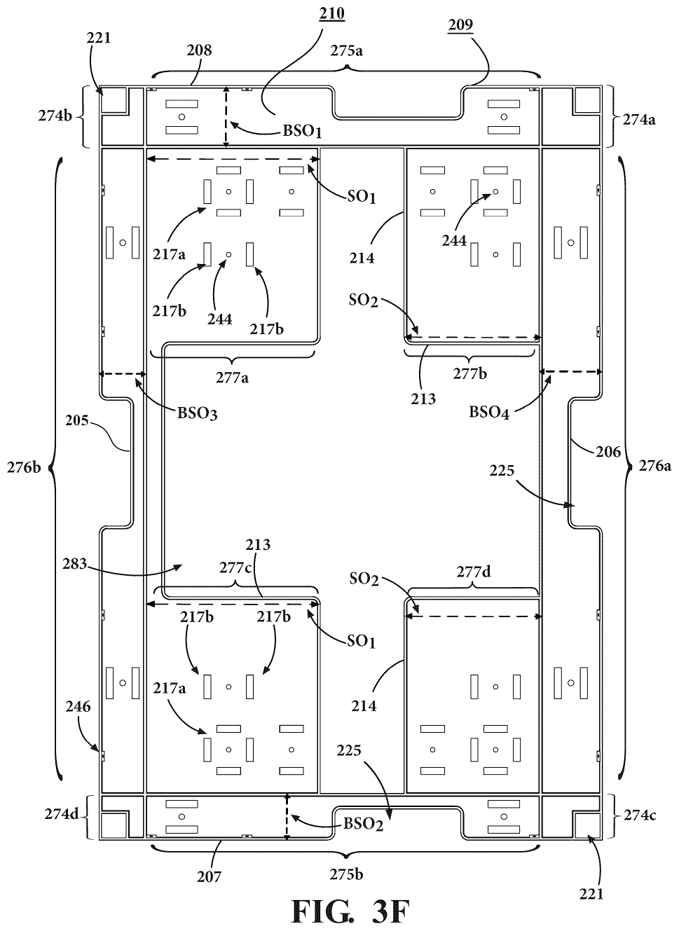

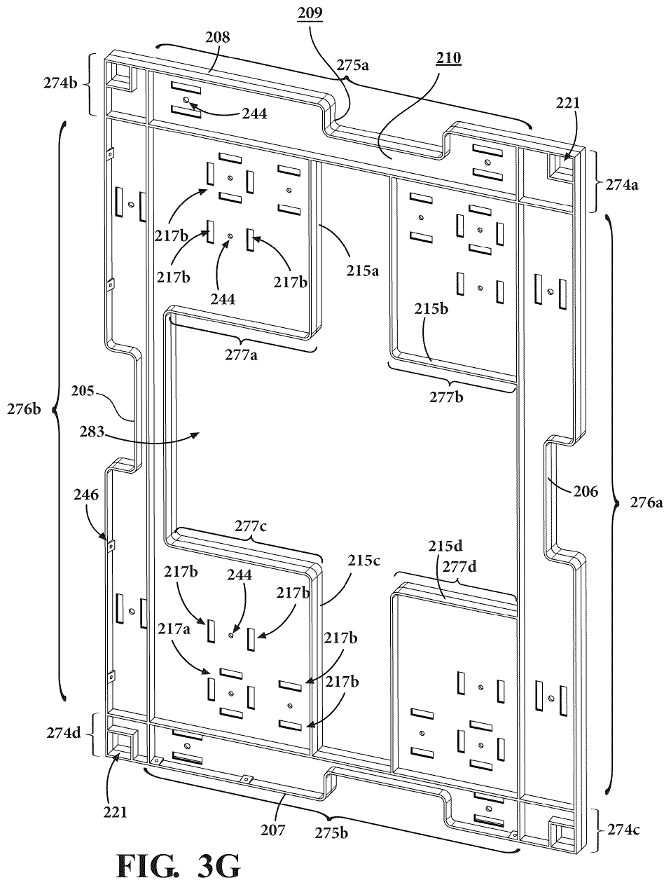

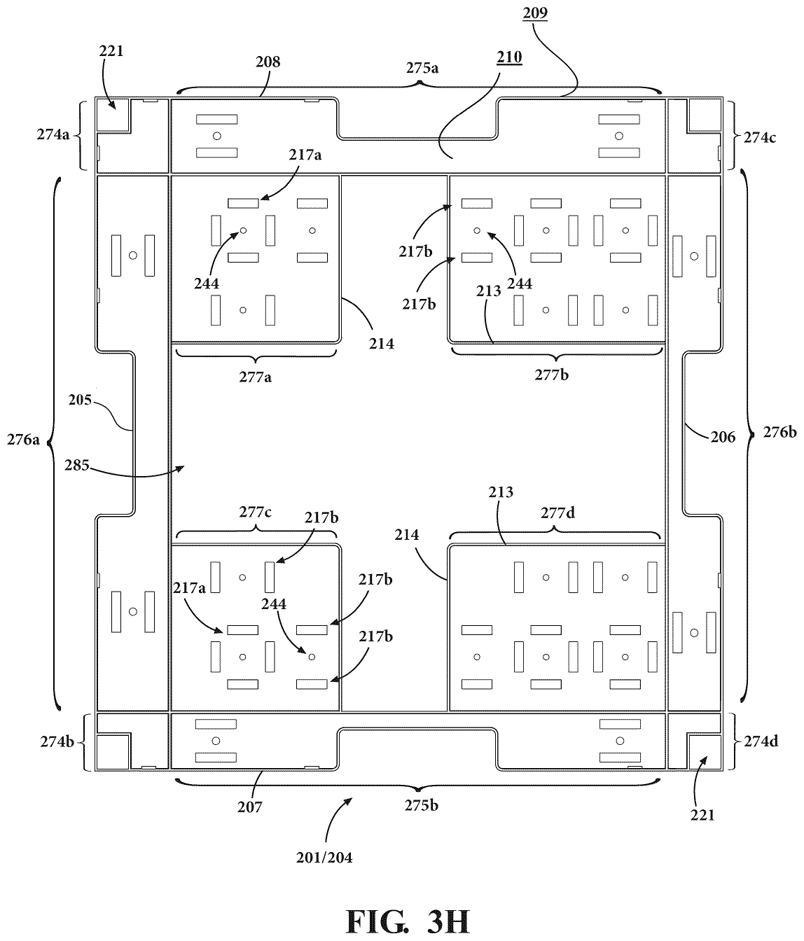

Now referring to FIGS. 3A-3B, illustrated is the upper cabinet structure 201 isolated from the remainder of the vehicle body 104. As shown in FIG. 3A, the upper cabinet structure 201 may comprise cabinets 286 of various sizing (width, height, depth), as the application and/or preference of the consumer may dictate. As explained in further detail herein, the upper cabinet structure 201 may also comprise a bridge-section 270 comprising a transition 271 from a larger cabinet size 272 to a smaller cabinet size 273, or vice-versa.

Referring to FIG. 3B, illustrated is the upper cabinet structure 201, and particularly a frame for the same, comprising a plurality of generally planar side panels 204. In embodiments, the plurality of side panels 204 may comprise a polyolefin, a thermoplastic, or a combination thereof. The polyolefin may include, but may not be limited to polypropylene (PP). The thermoplastic may include, but may not be limited to acrylonitrile butadiene styrene (ABS). The plurality of side panels 204 may also comprise a glass fiber filler for additional reinforcement.

Still referring to FIG. 3B, the upper cabinet structure 201 may comprise a first plurality of the side panels 204a and a second plurality of the side panels 204b. As shown, the upper edge 208 of the first plurality of the side panels 204a may be generally coplanar with the upper edge 208 of the second plurality of the side panels 204b. However, the lower edge 207 of the first plurality of the side panels 204a may be, by contrast, not generally coplanar with the lower edge 207 of the second plurality of the side panels 204b. Further, a height from the upper edge 208 to the lower edge 207 of the first plurality of side panels 204a may be greater than a height from the upper edge 208 to the lower edge 207 of the second plurality of side panels 204b.

Similarly, the upper cabinet structure 201 may comprise a third plurality of the side panels 204c, wherein the upper edge 208 of the second plurality of the side panels 204b may be generally coplanar with the upper edge 208 of the third plurality of the side panels 204c. However, the lower edge 207 of the second plurality of the side panels 204b may be, by contrast, not generally coplanar with the lower edge 207 of the third plurality of the side panels 204c. Further, a height from the upper edge 208 to the lower edge 207 of the third plurality of side panels 204c may be greater than a height from the upper edge 208 to the lower edge 207 of the second plurality of side panels 204b.

In embodiments, as shown in FIG. 2B, the bridge-section 270 may be utilized when the upper cabinet structure 201 is utilized in connection with the lower cabinet structure 200, with fixtures 288 mounted to the walls or floor 112 below the upper cabinet (TV, microwave, sink, oven, dishwasher, washer, dryer, etc.), or by general consumer preference, although this is not required.

Each of the plurality of side panels 204 may comprise a rear edge 205, a front edge 206, a lower edge 207, an upper edge 208, a first panel face 209, and a second panel face 210. The rear edge 205 may be disposed proximate or adjacent to one of the upstanding walls 116. The front edge 206 may oppose the rear edge 205 and may be distal to one of the upstanding walls 116. The upper edge 208 may be proximal or adjacent to the roof 120. The lower edge 207 may oppose the upper edge 208 and/or may be distal to the roof 120. The first panel face 209 and the second panel face 210 may oppose each other, and may also extend generally between the front edge 206 and rear edge 205 and the upper edge 208 and the lower edge 207 of the side panel 204, with exception for when an opening 283 is included in the side panel 204, as explained in further detail herein.

Referring now to FIGS. 3B-3D, the plurality of side panels 204 may further comprise a plurality of channels 221 extending between the first and second side panel 204 faces. The plurality of channels 221 may in turn be sized to receive a plurality of elongated tubular supports 220. In embodiments, two or more of the plurality of side panels 204 may comprise channels 221 in matching positions, such that the tubular supports 220 may extend through multiple side panels 204 and fix/orient the side panels 204 substantially parallel to each other.

While FIGS. 3B-3D illustrate the plurality of tubular supports 220 as square in cross-section, the plurality of tubular supports 220 may be any shape, including but not limited to any triangular shape, polygonal shape, circular shape, elliptical shape, or any variation or sub-combination thereof. As shown and previously stated, the tubular supports 220 may be sized to fit through the plurality of channels 221 of the plurality of side panels 204.

For example, as shown, at least one of the tubular supports 220 may extend from one of the channels 221 of one of the plurality of side panels 204 to a corresponding channel 221 of another one of the plurality of side panels 204. In such manner, the plurality of tubular supports 220 may interconnect the plurality of side panels 204 while also providing rigidity to the upper cabinet structure 201. The tubular supports 220 may also provide additional benefits as having a weight distribution function to the upper cabinet structure 201.

Moreover, as also shown in at least FIG. 3B, at least one of the plurality of channels 221 may be proximal a corner of the side panel 204 defined by the rear edge 205 and the upper edge 208, the corner defined by the front edge 206 and the upper edge 208, the corner defined by the rear edge 205 and the lower edge 207, the corner defined by the front edge 206 and the lower edge 207, or combinations thereof. Although not illustrated, it is contemplated that at least some of the plurality of channels 221 may be located at any position on the side panel 204, depending on the configuration of the plurality of side panels 204 and the sub-components used therein. Furthermore, as shown in FIG. 3B, not all of the plurality of channels 221 may be filled with the tubular supports 220, depending on the configuration.

In at least some embodiments, some of the plurality of tubular supports 220 may only extend through some of the plurality of side panels 204. For example, and as shown in FIG. 3B, the upper cabinet structure 201 may comprise first, second, third, and fourth pluralities of tubular supports 220a, 220b, 220c, and 220d. The first plurality of tubular supports 220a may extend from corresponding channels 221 proximate the upper edge 208 in the first plurality of side panels 204a to corresponding channels 221 proximate the upper edge 208 in the second plurality of side panels 204b and to corresponding channels 221 proximate the upper edge 208 in the third plurality of side panels 204c. In contrast, the second plurality of tubular supports 220b may extend only through corresponding channels 221 in the lower edge 207 of the first plurality of side panels 204a. The second plurality of tubular supports 220c may extend only though corresponding channels 221 in the lower edge 207 of the second plurality of side panels 204b. Further the second plurality of tubular supports 220d may extend only though corresponding channels 221 in the lower edge 207 of the third plurality of side panels 204c.

Although not shown, at least one of the tubular supports 220 may comprise an elbow joint (not illustrated), such that the tubular support 220 comprising the elbow joint may extend from one of the channels 221 of some of a plurality of side panels 204 to one of the channels 221 of a another plurality of side panels 204 arranged transverse to the first plurality of side panels 204. In such manner, the plurality of tubular supports 220 may interconnect the pluralities of side panels 204 while also providing rigidity to the upper cabinet structure 201, such as if the first and second pluralities of side panels 204 span a corner of the vehicle body 104.

However, while the plurality of channels 221 and the plurality of tubular supports 220 are illustrated and stated as one method for interconnecting the plurality of side panels 204 and/or providing rigidity to upper cabinet structure 201, other methods are also contemplated. For example, a plurality of generally horizontal members (not shown), such as a third plurality of side panels 204 (not shown), may be adjacent or proximal the rear edge 205 of at least some of the plurality of side panels 204, thereby interconnecting at least some of the plurality of side panels 204 and providing rigidity to the upper cabinet structure 201. Additionally or alternatively, the rear edge 205 of at least some of the plurality of side panels 204 may be coupled to at least one of the upstanding walls 116, thereby providing rigidity to the upper cabinet structure 201. In embodiments with at least one of the tubular supports 220 adjacent the rear edge 205 of the plurality of side panels 204, the at least one of the tubular supports 220 may additionally or alternatively be coupled to the at least one of the upstanding walls 116.

Moreover, as shown in at least FIGS. 3B-3C, the plurality of side panels 204 may comprise one or more mounts 246, which may comprise an associated mounting hole for receiving a fastener 247 for securing the side panel 204 to one or more of the generally upstanding walls 116, the roof 120, or combinations thereof, thereby providing rigidity to the upper cabinet structure 201. The fastener 247 may be any fastener 247 understood in the art, including but not limited to a bolt, a screw, a nail, a magnetic fastener, or combinations thereof.

Referring now to FIGS. 3B-3I, and as previously stated, each of the plurality of side panels 204 may comprise the front edge 206, the rear edge 205, the upper edge 208, and the lower edge 207. Without being limited by theory, the upper cabinet structure 201 may additionally or alternatively comprise the one or more power outlets, one or more fixtures 288, or both, or perforations 252 for accepting the same. The one or more power outlets may comprise the power outlet, as well as, but not limited to, associated housings, brackets, and electric wiring for supplying power to the power outlet. The one or more kitchen fixtures 288 may include, but may not be limited to a microwave, a fan, a sink, or combinations thereof.

Now referring back to FIG. 3A, the plurality of generally planar side panels 204 may also generally comprise a plurality of cosmetic panels 292. The plurality of cosmetic panels 292 may generally be positioned on an exterior and/or interior of the plurality of side panels 204.

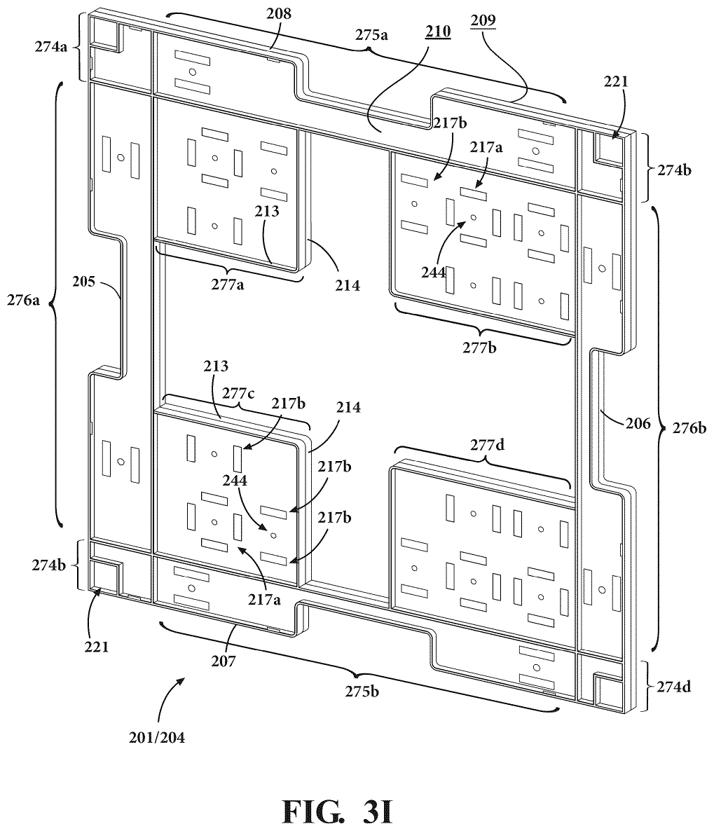

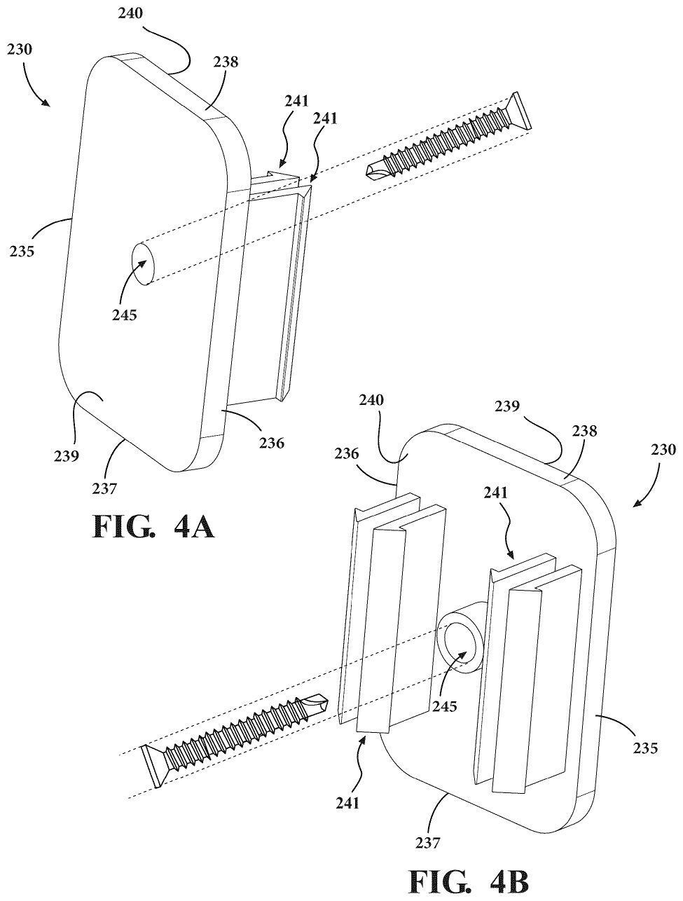

As shown in FIG. 3A, the plurality of cosmetic panels 292 may be coupled to at least one of the rear edge 205, the front edge 206, the upper edge 208, the lower edge 207, the first panel face 209, or the second panel face 210 of at least one of the plurality of side panels 204. Accordingly, the plurality of cosmetic panels 292 may cooperate to substantially obscure the said rear edge 205, front edge 206, upper edge 208, lower edge 207, first panel face 209, second panel face 210, or combinations thereof of one or more of the plurality of side panels 204 from an exterior view. In embodiments, the plurality of cosmetic panels 292 each may be coupled to one of the plurality of side panels 204 through a fastener 247, such as any of those fasteners previously discussed. Moreover, at least some of the plurality of side panels 204 may overlay a plurality of aperture reinforcements 230 mounted to the side panel 204, as described in further detail herein, such that the plurality of aperture reinforcements 230 may operate similar to a stud in drywall. For example, and as explained in further detail herein with respect to FIGS. 3D, 4A, and 4B, a plurality of fasteners may each extend through one of the aperture reinforcements 230 from the aperture reinforcement second face 240 through to one of the plurality of cosmetic panels 292, thereby coupling the one of the plurality of cosmetic panels 292 to the side panel 204.

The plurality of cosmetic panels 292 may comprise particle board, plywood, wood, plastic, composites, or any other material that may be considered aesthetic for cabinetry.

Now referring to FIGS. 3E-3I, each of the plurality of side panels 204 may further comprise sub-components therein. For example, and as shown at least in FIG. 3E, the plurality of side panels 204 may each comprise a plurality of mounting apertures 217 extending from the first panel face 209 to the second panel face 210, thereby defining a passage therethrough. As shown in FIG. 3E, the plurality of mounting apertures 217 in the side panels 204 may be arranged as a plurality of mounting aperture pairs 217, the individual mounting apertures 217 of the pair being slots which are arranged substantially parallel to each other.

In at least some embodiments, the pairs of mounting apertures 217 may also be arranged equidistant from a primary guide hole 244. For example, and in embodiments, the pairs of mounting apertures 217 and guide hole 244 may be arranged such that an aperture reinforcement 230 may be configured to anchor to the pair of mounting apertures 217 through a pair of snap fittings 241 protruding from a face of the aperture reinforcement 230. An aperture reinforcement 230 according to embodiments herein is shown for example in FIGS. 4A (front view) and 4B (reverse view).

Referring now to FIGS. 4A-4B, and similar to the plurality of side panels 204, each aperture reinforcement 230 may comprise an aperture reinforcement rear edge 235, an aperture reinforcement front edge 236 opposed to the aperture reinforcement rear edge 235, an aperture reinforcement lower edge 237, an aperture reinforcement upper edge 238 opposed to the aperture reinforcement lower edge 237, an aperture reinforcement first face 239, and an aperture reinforcement second face 240. As shown in at least FIGS. 3C and 3D, in at least some embodiments, the aperture reinforcement rear edge 235 may be proximal to the rear edge 205 of the side panel 204. Similarly, the aperture reinforcement front edge 236 may be distal to the rear edge 205 of the side panel 204. However, in at least some other embodiments, and also as shown in FIGS. 3C and 3D, the aperture reinforcement lower edge 237 may instead be proximal to the rear edge 205 of the side panel 204, whereas the aperture reinforcement upper edge 238 may be distal to the rear edge 205 of the side panel 204. As also shown, the aperture reinforcement 230 first and second faces may define a thickness of the plurality of aperture reinforcements 230.

While cantilever-type snap fittings 241 are shown in the drawings, any type of snap fitting 241 is contemplated for use herein, including but not limited to annular snap fittings 241 (wherein the mounting aperture 217 is flexible) or torsion snap fittings 241. The snap fittings 241 may also be complementary to the mounting apertures 217, i.e. each of the snap fittings 241 may be elongated with a slot width of the mounting apertures 217 similar to the distance between outer faces of the pair of snap fittings 241. Accordingly, each of the plurality of aperture reinforcements 230 may be configured to anchor to the pair of mounting apertures 217, the side panel 204 bearing the weight of the aperture reinforcement 230 and any additional features mounted thereon, as explained in further detail herein. Particularly, as shown in FIGS. 3B-3C, the aperture reinforcement second face 240 may be adjacent one of the first panel face 209 or the second panel face 210 of the side panels 204.

The aperture reinforcement 230 may similarly comprise a secondary guide hole 245 configured to substantially align with the primary guide hole 244 of the mounting aperture 217 pair when the aperture reinforcement 230 is anchored to the pair of mounting apertures 217 and thereby the side panel 204. Accordingly, the plurality of cosmetic panels 292 may be secured to the side panels 204 through a fastener 247 mounted through primary guide hole 244, or through the primary and second guide hole 244/245 combination (as shown for example in FIG. 3D). Further, due at least to the primary guide hole 244 extending through the side panel 204, the cosmetic panels 292 may be secured through a fastener from the backside (as shown for example in FIGS. 3D, 4A, and 4B), such that a head of the fastener is not observable from the outside of the upper cabinet.

Moreover, some or all of the plurality of side panels 204 may each further comprise an opening 283. As shown, each opening 283 may be positioned central to the respective side panel 204. In other words, the opening 283 may be positioned inboard in the side panel 204 from the rear edge 205, the front edge 206, the upper edge 208, and the lower edge 207, such that the opening defines an inboard rear edge 205′ opposed to the rear edge and adjacent the opening, an inboard front edge 206′ opposed to the front edge and adjacent the opening, an inboard upper edge 207′ opposed to the upper edge and adjacent the opening, and an inboard lower edge 208′ opposed to the lower edge and adjacent the opening, as shown in FIG. 3E

Referring back to FIGS. 3C-3D, and as previously stated, the upper cabinet structure 201 may also comprise a bridge-section 270 comprising a transition 271 from a larger cabinet size 272 to a smaller cabinet size 273 (a first transition 271), or from a smaller cabinet size 273 to a larger cabinet size 272 (a second transition 271). Accordingly, to accommodate the smaller cabinet size 273, at least some of the plurality of side panels 204 may vary in size. For example and as shown, the side panels 204 of the smaller cabinet size 273 may be affixed back-to-back with the side panels 204 of the large cabinet size 272 to form the bridge section 270.

For example, and in embodiments, a first series of the larger cabinet size 272 may be regarded as a first plurality of the side panels 204a, wherein a series of the small cabinet size 273 coupled to the first plurality of the side panels 204a may be regarded as a second plurality of the side panels 204b, and wherein a second series of the large cabinet size 272 coupled to the second plurality of the side panels 204b may be regarded as a third plurality of the side panels 204c. Accordingly, as shown, the upper edge 208 of the second plurality of the side panels 204b is generally coplanar with the upper edge 208 of the first and third pluralities of the side panels 204a and 204c. However, the lower edge 207 of the second plurality of the side panels 204b may not be generally coplanar with the lower edge 207 of the first and third pluralities of the side panels 204a and 204c. In other words, a height from the upper edge 208 to the lower edge 207 of the first and third pluralities of side panels 204a and 204c may be greater than a height from the upper edge 208 to the lower edge 207 of the second plurality of side panels 204b.

In embodiments including but not limited to those having the bridge-section 270, the plurality of matching aperture pairs 217, as well as the primary guide holes 244 therein, in the side panels 204 making up the smaller cabinet size 273 and the side panels 204 making up the larger cabinet size 272 may be configured such that they overlap. Accordingly, a fastener may be mounted between the side panels 204 to add additional rigidity to the transition 271 (also referred to herein as a crossover section). Further, as shown in FIGS. 3C-3D, at least some of the channels 221 in the larger side panel 272 may be configured to overlap with at least some of the channels 221 situated in the corners of the smaller side panels 273, such that the tubular supports 220 may be inserted and reinforce the stability of the bridge section 270.

As previously stated, each of the plurality of side panels 204 may further comprise sub-components therein. For example, and as shown in FIG. 3E, the plurality of side panels 204 may comprise a plurality of vertical ribs 214 and a plurality of horizontal ribs 213 extending perpendicular to the first panel face 209 or the second panel face 210. As shown, at least some of the plurality of vertical and horizontal ribs 214/213 may be positioned adjacent the edges of the side panel 204, i.e. extending from the first panel face 209 and/or the second panel face 210 adjacent the rear edge 205, front edge 206, lower edge 207, and upper edge 208. Accordingly, the side panel 204 may comprise a rear edge vertical rib 214a, a front edge vertical rib 214b, a lower edge horizontal rib 213a, and an upper edge horizontal rib 213b, and thereby defining an external ridge of the side panel 204 when the aforementioned ribs are connected.

Further, at least some of the plurality of vertical and horizontal ribs 214/213 may be positioned inboard of the vertical and horizontal ribs defining the external ridge of the side panel 204. For example, and in embodiments, at least some of the vertical and horizontal ribs may border the opening 283, i.e. defining an internal ridge of the side panel 204. Particularly, each of the plurality of side panels may comprises the opening 283 positioned inboard in the side panels from the rear edge, the front edge, the upper edge, and the lower edge; and the opening may define an inboard rear edge 205′ opposed to the rear edge and adjacent the opening, an inboard front edge 206′ opposed to the front edge and adjacent the opening, an inboard upper edge 207′ opposed to the upper edge and adjacent the opening, and an inboard lower edge 208′ opposed to the lower edge and adjacent the opening. Accordingly, the side panel 204 may similarly comprise an inboard rear edge vertical rib 214c, an inboard front edge vertical rib 214d, an inboard lower edge vertical rib 213c, and an inboard upper edge vertical rib 213d.

As also shown, the vertical and horizontal ribs 214/213 may also be interconnected such that the plurality of vertical ribs 214 and the plurality of horizontal ribs 213 together define distinct sections within the side panel 204 arranged around the opening 283, i.e. between the external and internal ridges. As shown in FIG. 3E, the vertical and horizontal ribs may define, in at least one embodiment, four corner sections 274a, 274b, 274c, and 274d, two generally lateral sections 275a and 275b extending between the corner sections 274 in a lateral direction, and two generally vertical sections 276a and 276b extending between the corner sections 274 in a vertical direction. For example, and as shown, the ribs 214a, 214c, 213c, and 213d may define the first vertical section 276a, the ribs 214a, 213a, 214c, and 213c may define the third corner section, the ribs 214c, 214d, 213a, and 213c may define the first lateral section 275a, the ribs 213a, 213c, 214d, and 214b may define the fourth corner section, the ribs 213c, 213d, 214d, and 214b may define the second vertical section 277b, the ribs 213d, 213b, 214d, and 214b may define the second corner section, and the ribs 213d, 213b, 214c, and 214d may define the second lateral section 275b.

Still referring to FIGS. 3E-3I, and as previously stated, the plurality of sub-panels may each comprise the opening 283, which may be positioned inboard to the front edge 206, the rear edge 205, the upper edge 208, and the lower edge 207 of each of the side panels 204. Accordingly, the opening 283 may thereby separate the first lateral section 275a from the second lateral section 275b in the vertical direction and separate the first vertical section 276a from the second vertical section 277b in the lateral direction.

As also shown in FIGS. 3E-3I, the aforementioned sections may be similar or dissimilar with respect to one or more sub-features within. For example, and as shown, the vertical sections 276a and 276b may each comprise one or more mounting aperture 217 pairs that are positioned at a same distance from the lower edge 207 and/or upper edge 208 as a corresponding mounting aperture 217 pair in the other vertical section 276. Similarly, the lateral sections 275a and 275b may each comprise one or more mounting aperture 217 pairs that are positioned at a same distance from the rear edge 205 and/or front edge 206 as a corresponding mounting aperture 217 pair in the other later section 275.

However, the corner sections 274, lateral sections 275, and vertical sections 276 may also be dissimilar in the lateral and/or vertical directions. Particularly, as shown in at least FIGS. 3E-3I, one corner section 274, vertical section 276, or lateral section 275 may have at least one dimension that is greater than a respective dimension of an opposing corner section 274, vertical section 276, or lateral section 275. Accordingly, each of the four corner sections 274 respectively, each of the two vertical sections 276 respectively, and each of the two lateral sections 275 respectively may have dissimilar dimensions with respect to the other sections.

For example, and as shown, the two pairs of corner sections (274a/274b & 274c/274d) positioned opposite each other by the lateral sections 275 in the lateral direction may be dissimilar in the lateral direction, i.e. corner sections 274a and 274c may have a greater dimension in the lateral direction than the respective two opposite corner sections 274b and 274d. Similarly, the two pairs of corner sections (274a/274b & 274c/274d) positioned opposite each other by the vertical sections 276 in the vertical direction may be dissimilar in the vertical direction, i.e. corner sections 274c and 274d may have a greater dimension in the vertical direction than the respective two opposite corner sections 274a and 274b.

Still referring to FIGS. 3E-3I, and as shown, the lateral sections 275a and 275b positioned opposite each other by the vertical sections 276 in the vertical direction may be dissimilar in the vertical direction, i.e. lateral section 275b may have a greater dimension in the vertical direction than the opposite lateral section 275a.

Similarly, the vertical sections 276a and 276b positioned opposite each other by the lateral sections 275 in the lateral direction may be dissimilar in the lateral direction, i.e. vertical section 276a may have a greater dimension in the lateral direction than the opposite vertical section 276b.

Without being limited by theory, and referring in particular to FIG. 3F, the aforementioned dissymmetries as to the lateral sections 275a and 275b may be advantageous in permitting pairs of the side panels 204 to be flipped in the vertical direction (i.e. rotated 180 degrees) to accommodate a different base shelf thickness, as per manufacturer's requirement. Without being limited by theory, being able to accommodate different base shelf thicknesses may be beneficial in terms of accommodating wiring for under cabinet lighting or otherwise. For example, and as shown, the plurality of side panels 204 may comprise a plurality of recesses 225 in the front edge 206, the rear edge 205, the portion of the side panel 204 proximate the front edge 206 and bordering the opening 283, the portion of the side panel 204 proximate the front edge 206 and bordering the opening 283, or combinations thereof.

Accordingly, still referring to FIG. 3F, the first lateral section 275a and the second lateral section 275b may have a vertical dimension such that the two common base shelf thicknesses (1.5 inches and 2 inches) are possible by flipping the side panels 204 vertically. In other words, and in embodiments, the first lateral section 275a may define a first base shelf offset dimension (BSO₁) in the vertical direction, and the second lateral section 275b may define a second base shelf offset dimension (BSO₂) in the vertical direction. In embodiments, the first and second base shelf offset dimensions may be dissimilar, i.e. the first base shelf offset dimension may be greater than the second base shelf offset dimension.

As previously stated, the plurality of side panels 204 may be defined by the vertical sections 276 and the lateral sections 275. In at least some embodiments, the longitudinal dimension of the vertical sections 276 and the lateral sections 275 may be similar or dissimilar, i.e. the plurality of side panels 204 may be square or rectangular. Without being limited by theory, this may be of some advantage, in conjunction with the plurality of mounting apertures 217, in allowing the plurality of side panels 204 to be rotated 90 degrees and thereby be ‘deep’ cabinetry, such as for primarily mounting drawers, instead of ‘tall’ cabinetry for primarily mounting shelves.

Further, without being limited by theory, the aforementioned dissymmetry's as to the vertical sections 276 may thus be advantageous in permitting pairs of the side panels 204 to be flipped in the vertical direction (i.e. rotated 180 degrees) when in the ‘deep’ orientation and still accommodate a different base shelf thickness, as per manufacturer's requirement. Particularly, the first vertical section 276a may define a third base shelf offset dimension (BSO₃) in the lateral direction, and the second vertical section 277b may define a fourth base shelf offset dimension (BSO₄) in the lateral direction. In embodiments, the third and fourth base shelf offset dimensions may be dissimilar, i.e. the third base shelf offset dimension may be greater than the fourth base shelf offset dimension. Further, the first base shelf offset dimension may be similar to the third base shelf dimension. Likewise, the second base shelf offset dimension may be similar to the fourth base shelf dimension, such that similar base shelf thickness may be accommodated regardless of the ‘deep’ or ‘tall’ orientation of the plurality of side panels 204.

In at least some embodiments, the side panels 204 may comprise additional sections from that previously discussed with respect to FIG. 3E. For example, and as shown in FIGS. 3F-3I, the side panels 204 may further comprise a plurality of inboard corner sections 277 disposed inboard of the lateral sections 275 and vertical sections 276, the plurality of inboard corner sections 277 defined by the vertical ribs 214 and the horizontal ribs 213, such that a secondary inboard ridge is defined by the vertical and horizontal ribs. For example, and as shown in FIG. 3F, the side panel 204 may comprise a plurality of inboard elbow ribs 215a, 215b, 215c, and 215d, each of which comprises a joined vertical rib and horizontal rib, an elbow defined at the transition between the vertical rib 214 and the horizontal rib 213.

In embodiments a first inboard elbow rib 215a may define a first inboard corner section 277a disposed proximate to and inboard of the first vertical section 276a and the first lateral section 275a. The second inboard elbow rib 215b may define a second inboard corner section 277b disposed proximate to and inboard of the second vertical section 277b and the first lateral section 275a. A third inboard elbow rib 215c may define a third inboard corner section 277c disposed proximate to and inboard of the first vertical section 276a and the second lateral section 275b. A further inboard elbow rib 215d may define a fourth inboard corner section 277d disposed proximate to and inboard of the second vertical section 277b and the second lateral section 275b.

In at least some embodiments, these inboard elbow ribs 215 may themselves be interconnected, although this is not required. The inboard corner sections 277 may additionally comprise one or more mounting aperture 217 pairs, as well as one or more primary guide holes 244, similar to the remaining sections of the side panels 204.

Still referring to FIGS. 3F-3I, the mounting apertures 217 and aperture reinforcements 230 positioned in the inboard corner sections 277 may be used to mount one or more additional features inside the upper cabinet structure 201. For example, the upper cabinet structure 201 may further comprise one or more drawers, one or more shelves, the one or more power outlets, the one or more fixtures, or combinations thereof. To mount the aforementioned additional features, and particularly the one or more shelves, the upper cabinet structure 201 may further comprise one or more shelf pilasters 285, (as shown in at least FIGS. 2A and 3A) which be mounted on the cosmetic panels 292 at a location also concurrent with the aperture reinforcements 230 on the mounting apertures 217 of the inboard corner sections 277. Still referring to FIGS. 3F-3I, at least two of the mounting aperture pairs 217 may share a guide hole 244 in each of the inboard corner sections 277, i.e. the inboard corner sections 277 may comprise a bi-positional mounting aperture group 217a. In other words, some of the guide holes may comprise four mounting apertures 217 equidistant the guide hole 244 and rotated 90 degrees with respect to the nearest mounting apertures 217. Without being limited by theory, this may enable the aperture reinforcements 230, and particularly the snap fittings of the same, to be oriented in the mounting apertures 217 for a maximum weight distribution on the snap fittings regardless of whether the side panels 204 are oriented for ‘tall’ cabinetry or ‘deep’ cabinetry. Further, the inboard corner sections 277 may comprise at least two mounting aperture pairs 217 and associated guide holes offset from the guide hole 244 comprising the four mounting apertures 217, i.e., offset mounting aperture pairs 277b, the slots of at least one of the offset mounting aperture pairs 277b having an orientation on a longitudinal axis parallel to the lower edge 207 and/or upper edge 208, and the slots of at least one of the other offset mounting aperture pairs 277b having an orientation on a longitudinal axis parallel to the rear edge 205 and/or front edge 206. Accordingly, the offset mounting aperture pairs 277b, and aperture reinforcements 230 in the same, may provide additional anchoring points for the shelf pilasters complementary with the bi-positional mounting aperture group 217a regardless of whether the side panels 204 are oriented for ‘tall’ cabinetry or ‘deep’ cabinetry.

Now referring to FIGS. 3F-3I, the inboard corner sections 277 may also be dissimilar in one or more directions similar to the corner sections 274 previously described. For example, and as shown, the two pairs of inboard corner sections (277a/277b & 277c/277d) positioned opposite each other in the lateral direction may be dissimilar in the lateral direction, i.e. the inboard corner sections 277a and 277c may have a greater dimension in the lateral direction than the respective two opposite inboard corner sections 277b and 277d.

In other words, and in embodiments, the inboard corner sections 277a and 277c may define a first shelf pilaster offset dimension (SPO₁) in the lateral direction, and the two opposite inboard corner sections 277b and 277d may define a second shelf pilaster offset dimension (SPO₂) in the lateral direction. In embodiments, the first and second shelf pilaster offset dimensions may be dissimilar, i.e. the first shelf pilaster offset dimension may be greater than the second shelf pilaster offset dimension.

Referring back to FIG. 3B, in at least some embodiments the upper cabinet structure 201 may comprise internal cosmetic panels 293 as well as external cosmetic panels 292 to obscure the side panels 204 and/or tubular supports 220. However, it may also be desired by a consumer to have under-cabinet lighting, such as if the upper cabinet structure 201 is utilized in a kitchen space.

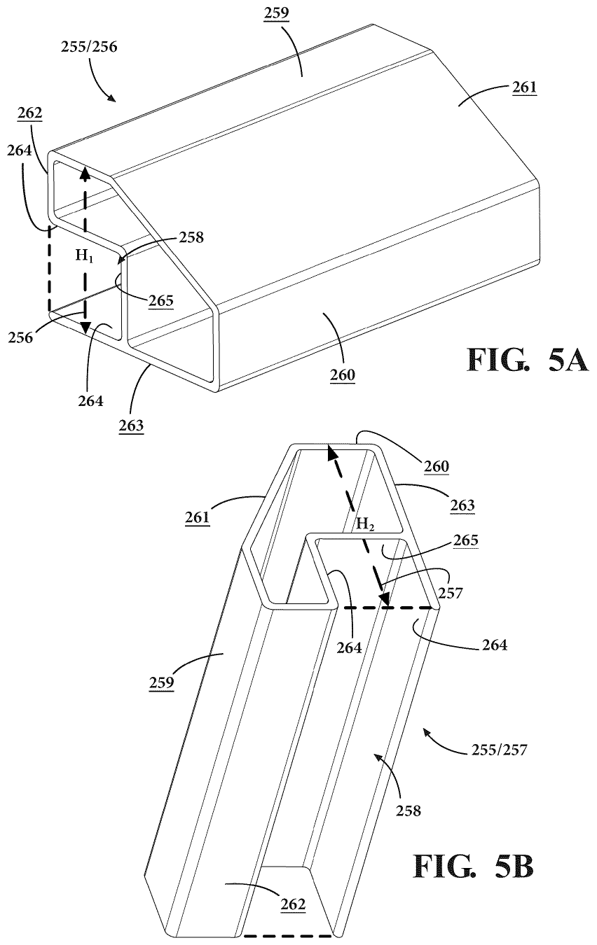

Accordingly, and referring to FIGS. 3B, 5A and 5B, to accommodate the wires, wire harnessing, and lights to be mounted between the internal cosmetic panels 293 and external cosmetic panels 292, the upper cabinet structure 201 may further comprise one or more spacers 255 configured to mount on the one or more tubular supports 220, such as via an insert 258 in the spacer 255. For example, and as shown, the one or more spacers 255 may be mounted on the one or more tubular supports 220 interconnecting the corner sections 274c and 274d of the side panels 204. The one or more spacers 255 may operate to increase a spacing between the internal cosmetic panels 293 and external cosmetic panels 292 when mounted, thereby accommodating the wires, wire harnessing, and lights.

As shown, the spacer 255 may comprise the insert 258 comprising opposite insert walls 264 and a tubular support mounting face 265 for receiving the tubular support 220 in the spacer 255 and mounting the spacer 255 on the tubular support 220, the tubular support mounting face 265 defining a transition between the opposite insert walls 264. As also shown, the spacer 255 may comprise a transition face 261 positioned between the primary mounting face 259 and the secondary mounting face 260 and oriented at a transverse angle with respect to the primary and secondary mounting faces 259/260. Further yet, the spacer 255 may comprise a secondary orientation backing face 262 positioned between the insert 258 and the primary mounting face 259, i.e. defining a transition between the insert 258 (one of the insert walls 264) and the primary mounting face 259. Similarly, the spacer 255 may comprise a primary orientation backing face 263 positioned between the insert 258 and the secondary mounting face 260, i.e. defining a transition between the insert 258 (the other of the insert walls 264) and the secondary mounting face 260. Further, as shown, the spacers 255 may be substantially hollow so as to minimize the weight of the cabinetry described herein.

Further, as shown in FIGS. 5A-5B, the one or more spacers 255 may be configured such that they may be mounted on the tubular supports 220 with a primary orientation 256 (FIG. 5A) and a primary mounting face 259, or rotated 90 degrees and mounted with a secondary orientation 257 (FIG. 5B) and a secondary mounting face 260. In at least these embodiments, the secondary orientation 257 and the secondary mounting face 260 may operate to create a greater degree of spacing, i.e. between the internal and external cosmetic panels 292/293, than the primary orientation 256. In other words, the height H₁ of the spacer 255 from the primary orientation mounting face 259 to the primary orientation backing face 263 (in the primary orientation 256) may be less than the height H₂ from the secondary orientation mounting face 260 to the secondary orientation backing face 262 (in the secondary orientation 257).

Accordingly, the primary orientation 256 of the spacer 255 on the tubular support 220 may be defined by the secondary mounting face 260 being distal the floor 112 and the secondary mounting backing face being proximate the floor 112. Similarly, the secondary orientation 257 of the spacer 255 on the tubular support 220 may be defined by the primary mounting face 259 being distal the floor 112 and the primary mounting backing face being proximate the floor 112.

As previously stated, and with reference to FIGS. 2A and 2B, the RV and the vehicle body 104 may additionally or alternatively comprise a dinette having one or more seating elements 202 and/or a table (not shown). In embodiments, the one or more seating elements 202 may generally comprise a base 253 and backing 254, which may or may not be padded. However, the inclusion of a base 253 and backing 254 is not explicitly required, such as for example, when the one or more seating elements 202 comprise barstools that may or may not lack a back. Further, while a bench-type seating element 202 is shown in FIGS. 2A-2B, it is contemplated that the seating element 202 may comprise any seating element design 202 known in the art, as the consumer preference may dictate.

As also shown by FIGS. 2A-2B, the one or more seating elements 202 may be in contact with one or more of the upstanding walls 116, the floor 112, or both. Similarly, the table may be in contact with one or more of the upstanding walls 116, the floor 112, or both (although not shown). For example, and in embodiments, the table may be a folding-Murphy-table (connected to only one of the upstanding walls 116) or a floor-mounted table (connected to only the floor 112).

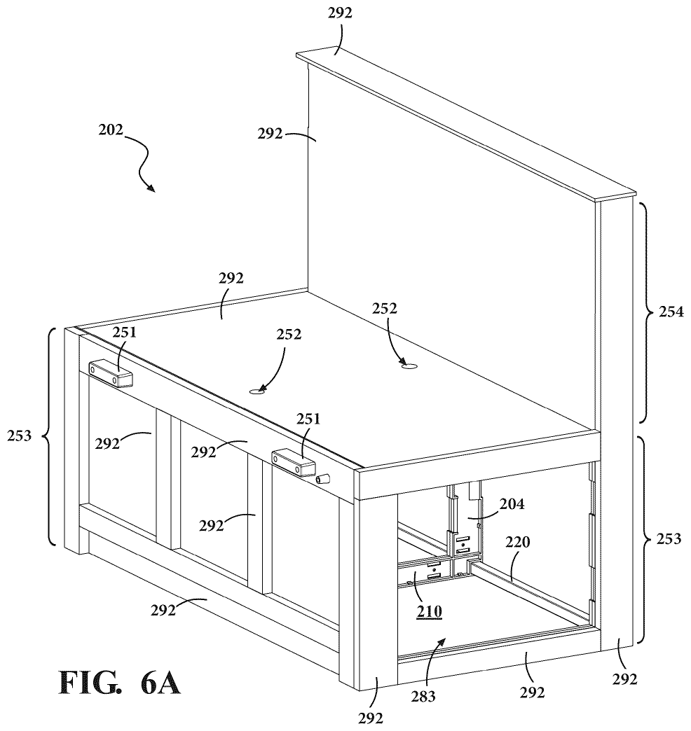

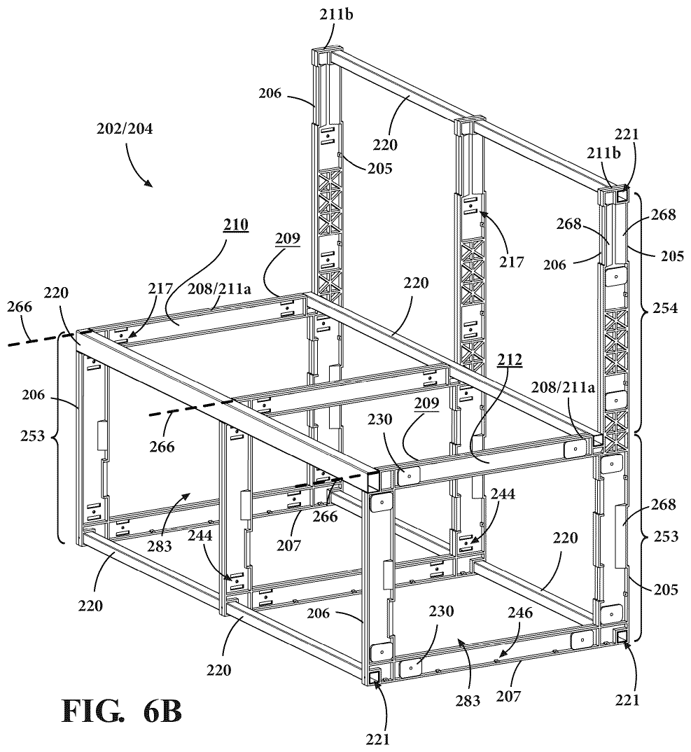

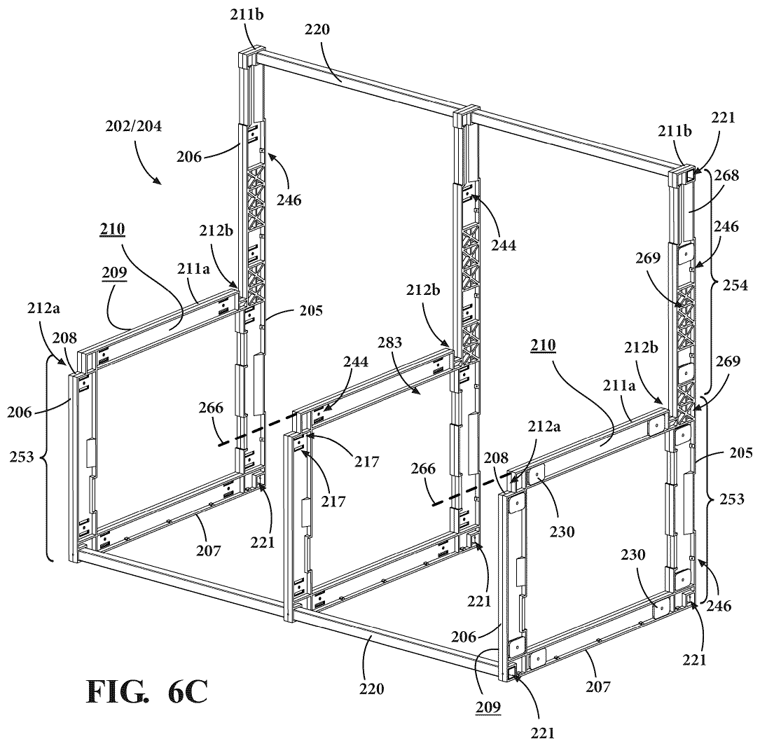

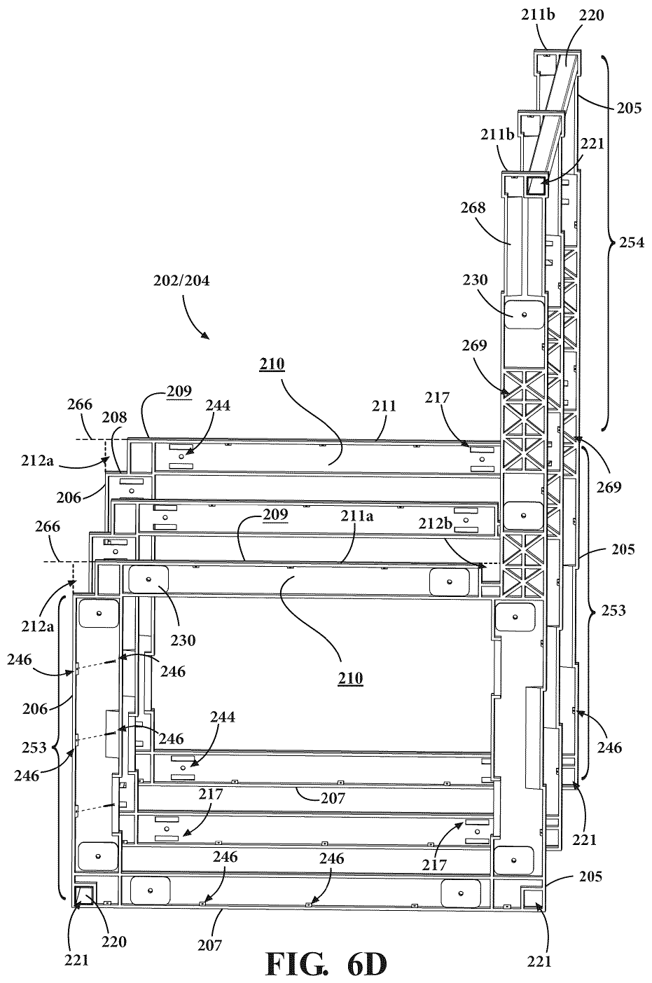

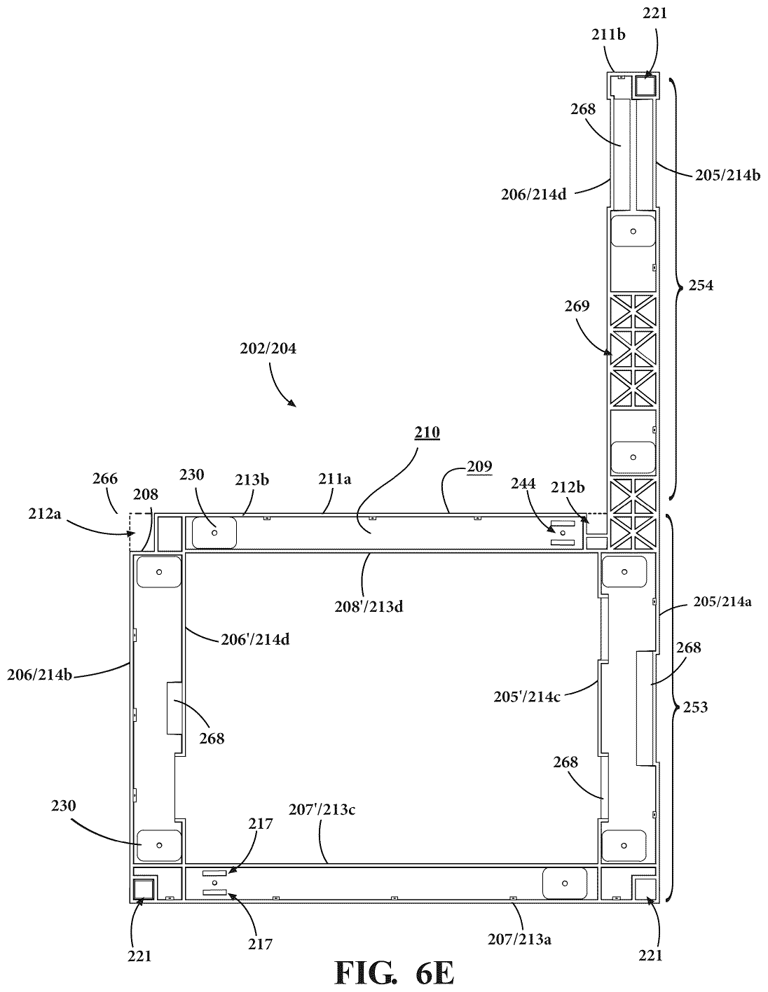

Now referring to FIGS. 6A-6E, illustrated is the seating element 202 of the dinette in further detail. Similar to the cabinet structures, the seating element 202 may comprise an open frame with a plurality of cosmetic panels 292, substantially obscuring the internal frame. Moreover, as shown in FIG. 6A, the exterior cosmetic panels 292 forming a top surface 266 of the base 253 may comprise one or more perforations 252 extending through the exterior cosmetic panel 292. In embodiments, these perforations 252 may be sized such that the exterior cosmetic panel 292 making up the top surface 266 of the base 253 may be gripped and removed by a user, wherein the gaps in the open frame of the base 253 of the seating element 202 may be used for storage within the RV/vehicle body 104. Alternatively or additionally, one of the external cosmetic panels 292 of the base 253 of the seating element 202 of the dinette may comprise the one or more perforations 252 (although not shown), such that the cosmetic panels 292 may be removable by a user and the gaps in the open frame of the base 253 used for storage.

Still referring to FIG. 6A, and in embodiments, one or more of the perforations 252 of the base 253 may have purposes in addition to or alternatively from the removal of the cosmetic panel 292. For example, and in embodiments, one or more of the perforations 252 may be sized and positioned so as to receive a lap safety belt for securing a user while the RV is in motion. The cosmetic panel 292 forming the top of the base 253 may also comprise one or more slots or fasteners (not illustrated) for mounting a pad and/or the lap belt on top of the base 253, as the comfort/preference of the consumer may dictate.

Now referring to FIGS. 6B-6E, and as previously stated, the seating element 202 may further comprise a frame, which may be similar or identical to the frame for the lower or upper cabinet structures 200/201. For example, and as shown in FIGS. 6B-6E, the frame of the seating element 202 may comprise a plurality of generally planar side panels 204. In other words, and in embodiments, the base 253 and the backing 254 of the seating element 202 may be formed from the plurality of side panels 204.

Each of the plurality of side panels 204 of the frame of the seating element 202 may similarly comprise the rear edge 205, the front edge 206, the lower edge 207, the upper edge 208, the first panel face 209, and the second panel face 210. The lower edge 207 may be proximal or adjacent to the floor 112. The upper edge 208 may oppose the lower edge 207 and/or may be distal to the floor 112. The first and second panel faces may extend generally between the front edge 206 and rear edge 205 and the upper edge 208 and the lower edge 207 of the side panel 204, with exception for when an opening 283 is included in the side panel 204, similar to the upper and lower cabinet structures 201/200. For example, and in embodiments, the opening 283 may be positioned central to the side panel 204. In other words, the opening 283 may be positioned inboard in the side panel 204 from the rear edge 205, the front edge 206, the upper edge 208, and the lower edge 207, so as to provide an open receptacle for storage in the base 253 of the seating element 202, as explained herein. For example, and similar to the cabinets 286, the opening 283 may be positioned inboard in the side panel 204 from the rear edge 205, the front edge 206, the upper edge 208, and the lower edge 207, such that each of the side panels 204 may comprise an inboard rear edge 205′, an inboard front edge 206′, an inboard upper edge 207′, and an inboard lower edge 208′ defining the opening 283, as shown for example in FIG. 6E. As also shown, the first and second panel faces may also define a thickness of the plurality of generally planar side panels 204.

In at least some embodiments, the front and rear edges, and the first and second faces, of the plurality of side panels 204 of the seating element 202 may vary in their positioning with respect to the walls and floor 112 dependent on the base 253 and/or general orientation of the seating element 202, as shown for example in FIG. 2B.

Referring again to FIGS. 6B-6E, the plurality of side panels 204 of the seating element 202, similar to the plurality of side panels 204 of the upper and lower cabinet structures 201/200, may further comprise sub-components therein. For example, and in embodiments, the plurality of side panels 204 of the seating element 202 may further comprise the plurality of channels 221 extending between the first panel face 209 and second panel face 210 and the plurality of channels 221, similar to the upper and lower cabinets 286. Further, in embodiments, two or more of the plurality of side panels 204 may comprise channels 221 in matching positions, such that the tubular supports 220 may extend through multiple side panels 204 and fix/orient the side panels 204 substantially parallel to each other in the frame of the seating element 202.

Moreover, as shown in FIGS. 6B-6C, at least one of the plurality of channels 221 may be proximal a corner of the side panel 204 defined by the rear edge 205 and the upper edge 208, the corner defined by the front edge 206 and the upper edge 208, the corner defined by the rear edge 205 and the lower edge 207, the corner defined by the front edge 206 and the lower edge 207, or combinations thereof. Although not illustrated, it is contemplated that at least some of the plurality of channels 221 may be located at any position on the side panel 204, depending on the configuration of the plurality of side panels 204 and the sub-components used therein. Furthermore, as shown in FIG. 3B, not all of the plurality of channels 221 may be filled with the tubular supports 220, depending on the configuration.

Additionally or alternatively, at least a corner of the side panel defined by the front edge and the upper edge may not include a bounded channel 221 for receiving the tubular supports 220. Instead, the upper edge of each of the plurality of side panels may comprise a first ledge 212a adjacent the front edge 206 and a second ledge 212b proximal the rear edge 205 of each of the plurality of side panels 204, the first and second ledges 212a/212b being closer to the lower edge 207 than a remainder of the upper edge (i.e. remaining first portion 211a and/or remaining second portion 212a) is to the lower edge. As shown, the first portion 211a may be elongate, i.e. may form a majority of the total length of the upper edge 208 as compared to the first ledge, the second ledge, and the second portion 211b. Accordingly, each of the at least one tubular supports 220 positioned in the ledges 212a/212b may extend from one of the ledges 212a/212b of one of the plurality of side panels 204 to a corresponding ledge 212a/212b of another of the plurality of side panels 204. Further, the ledges may be configured such that an upper surface 220′ of the tubular supports positioned in the ledges 212a/212b is coplanar with the remainder(s) of the upper edge 208.

Further, the first portion 211a of the remainder of the upper edge 208 may be positioned between the first and second ledges 212a/212b, a second portion 211b of the remainder of the upper edge 208 may be positioned between the second ledge 212b and the rear edge 205 of each of the plurality of side panels 204, and the second portion 212b of the remainder of the upper edge 208 may define the backing 254 of the seating element

Without being limited by theory, and in at least some embodiments bounding the tubular supports 220 within a channel 221 proximal the upper edge 208 may not be desired due to disruption in the generally planar surface defined by the combination of the table (generally planar span) and cosmetic panel 292 making up the top surface 266 of the base 253 of the seating element 202 when the dinette is arranged into a sleeping surface. Particularly, the ledges may be sized such that the tubular support 220 is coplanar with the elongate protrusion 212a. Accordingly, by the ledges being configured such that an upper surface 220′ of the tubular supports positioned in the ledges 212a/212b is coplanar with the remainder(s) of the upper edge 208, the weight of a user sleeping may be evenly distributed across the upper edge 208 of the plurality of side panels 204.

Still referring to FIGS. 6B-6E, the plurality of side panels 204 of the seating element 202, similar to the upper and lower cabinets 286, may also comprise the plurality of mounting apertures 217. The plurality of mounting apertures 217 in the side panels 204 may also similarly be arranged as a plurality of mounting aperture pairs 217 that may be equidistant from a primary guide hole 244. The pairs of mounting apertures 217 and guide hole 244 may also be arranged such that an aperture reinforcement 230 may be configured to anchor to the pair of mounting apertures 217 through a pair of snap fittings 241 protruding from a face of the aperture reinforcement 230, the aperture reinforcement 230 being similar or identical to the aperture reinforcement 230 for the upper and lower cabinet structures 201/200. The additional features inside the seating element 202 may also be similar or identical to the upper or lower cabinet structures 201/200. For example, and in embodiments, the seating element 202's base 253 may comprise the one or more drawers, the one or more shelves, the one or more power outlets, the one or more fixtures 288, one or more cabinets 286, or combinations thereof. To mount the aforementioned additional features, the base 253 may further comprise one or more shelf pilasters 285 (similar to the cabinets 200/201 in FIG. 2B illustrating the shelf pilasters 285), which may themselves be mounted on the aperture reinforcements 230, such as over the interior cosmetic panels 293. The side panels 204 may themselves comprise one or more additional features or additional mounting apertures/primary guide holes 244 to accommodate the shelf pilasters 285 or the bumpers 251, as previously explained.

In embodiments, and as shown by at least FIGS. 6B-6E, the plurality of side panels 204 may comprise one or more sub-components to prevent the seating element 202 frame from collapsing when exposed to weight on the base 253 and/or shear on the backing 254. As shown in FIGS. 6B-6E, a portion of the side panel 204 immediately adjacent or defining the rear edge 205, the front edge 206, the lower edge 207, the upper edge 208, or combinations thereof may be raised with respect to the first panel face 209, the second panel face 210, or both, which may or may not also make up the vertical or horizontal ribs 213, as previously described. Without being limited by theory, this may provide further structural stability to the side panels 204, similar to a I-beam.

As also shown in FIGS. 6B-6E, the plurality of side panels 204 may comprise one or more reinforcement features 268 to help prevent the base 253 from folding and internal ribbing 269 to prevent the backing 254 from shearing or bending.

For example, and as shown, the plurality of side panels 204 may comprise a plurality of recesses 225 in the front edge 206, the rear edge 205, the portion of the side panel 204 proximate the front edge 206 and bordering the opening 283, the portion of the side panel 204 proximate the front edge 206 and bordering the opening 283, or combinations thereof abutting the reinforcement features 268, such as for accommodating a wire harness. Accordingly, and as shown in at least FIG. 6B, each of the reinforcement features 268 may provide backing 254 to the rear edge 205 or the front edge 206 for providing additional support to the side panels 204 to counteract the structural weakness of the plurality of recesses 225. Further, each of the reinforcement features 268 may be sloped, i.e., may slope downward from the raised portion of the rear edge 205, the front edge 206, the lower edge 207, or the upper edge 208 to the first panel face 209 or second panel face 210 for further structural reinforcement.

Similarly, and now referring back to FIGS. 3B-3I, the plurality of side panels 204 of the upper or lower cabinetry may similarly comprise the reinforcement features 268 and the plurality of recesses 225, such as in the front edge 206, in the rear edge 205, in the upper edge 208, in the lower edge 207, or proximate any one of the previous and bordering the opening 283, or combinations thereof.

Referring back to FIGS. 6B-6E, the plurality of side panels 204 may also comprise internal ribbing 269 to prevent the backing 254 from shear in addition to or as an alternative to the reinforcement features 268.

Still referring to FIGS. 6B-6E, the plurality of side panels 204 may also comprise the plurality of vertical and horizontal ribs 213 similar or identical to the upper cabinetry 201, which may be interconnected such that the plurality of vertical and horizontal ribs 213 define distinct sections within the side panel 204 arranged around the opening 283.

Still referring to FIG. 6E, in at least some embodiments, the side panels 204 and/or resulting base 253 of the seating element 202 may be rectangular or square. Further, the third vertical section 276 may have a different thickness than the other two vertical sections 276, such that the base 253 of the seating element 202 may be a high-backed seating element 202 or a low-back seating element 202, for example.

Without being limited by theory, it may also be desired by a consumer to maximize the internal space of the RV for potential sleeping arrangements. Accordingly, the dinettes described herein may be convertible to a temporary bed. For example, and as shown in FIG. 2A, the dinette may comprise two seating elements 202 generally opposed to each other, as well as a table (not illustrated) interposed between.

In other words, and as shown, the front edge 206 (or the external cosmetic panel 292 placed thereon) of the plurality of side panels 204 of a first seating element 202a may generally be opposed to the front edge 206 (or the external cosmetic panel 292 placed thereon) of the plurality of side panels 204 of second seating element 202b. As shown in FIG. 6A, the base 253 may comprise one or more bumpers 251 positioned on a cosmetic panel 292 coupled to the front edge 206 that are opposed to corresponding bumpers 251 coupled to a cosmetic panel 292 on the opposing front edge 206 of the opposing side panels 204 of the opposing seating element 202. In embodiments, the cosmetic panel 292 coupled to the front edge 206 may be coupled through the use of a fastener through a mount 246 adjacent the front edge 206, such as shown in FIG. 6D.

Referring to FIG. 2A, and in embodiments, the opposing base 253 of the (opposing) second seating element 202 may be spaced such that the table or a generally planar panel 248, sized to span a distance between the front edges of the two seating elements 202, may be interposed between the bases 253 and such that the table or generally planar panel 248 rests on the bumpers 251. Accordingly, when a cosmetic panel 292 is positioned on the first portion 211a of the remainder of the upper edge and the tubular supports 220 disposed on the first and second ledges 212a/212b of each of the plurality of side panels 204, the first portion 211a and the tubular supports 220 disposed on the first and second ledges 212a/212b of each of the plurality of side panels may be obscured by the cosmetic panel and a substantially coplanar surface 250 may be defined with the cosmetic panel 292 positioned on the upper edge 208 of the plurality of side panels 204 of each of the seating elements 202.

The disclosure herein may include one or more aspects. A first aspect may include a recreational vehicle of the type comprising a living space, the recreational vehicle comprising a generally horizontal floor and a vehicle body comprising a plurality of generally upstanding walls defining the living space in conjunction with the generally horizontal floor, each of the plurality of generally upstanding walls comprising a bottom adjacent the floor and a top distal to the floor.

A second aspect may include the first aspect, and may further comprise a seating element in contact with the horizontal floor, the seating element comprising a plurality of tubular supports and a plurality of generally planar side panels each comprising a rear edge, a front edge, a lower edge adjacent the horizontal floor, and an upper edge distal to the floor, and wherein: the upper edge of each of the plurality of side panels comprises a first ledge adjacent the front edge and a second ledge proximal the rear edge of each of the plurality of side panels, the ledges being closer to the lower edge than a remainder of the upper edge is to the lower edge, each of tubular supports extends from one of the ledges of one of the plurality of side panels to a corresponding ledge of another of the plurality of side panels, and the ledges are configured such that an upper surface of the tubular supports positioned in the ledges are coplanar with the remainder of the upper edge.

A third aspect may include the second aspect, wherein a first portion of the remainder of the upper edge is positioned between the first and second ledges; a second portion of the remainder of the upper edge is positioned between the second ledge and the rear edge of each of the plurality of side panels; and the second portion of the remainder of the upper edge defines the backing of the seating element.

A fourth aspect may include either the second or third aspects, and wherein the seating element comprises a cosmetic panel positioned on: a portion of the remainder of the upper edge positioned between the first and second ledges; and the tubular supports disposed on the first and second ledges of each of the plurality of side panels, thereby: obscuring the portion of the remainder of the upper edge positioned between the first and second ledges and the tubular supports disposed on the first and second ledges of each of the plurality of side panels, and defining a substantially coplanar surface.

A fifth aspect may include the fourth aspect, wherein the seating element comprises: an additional cosmetic panel coupled to the front edge of each of the plurality of side panels; and a plurality of bumpers coupled to the additional cosmetic panel coupled to the front edge of each of the plurality of side panels.

A sixth aspect may include the fifth aspect, and may further comprise two of the seating elements and a generally planar panel positioned therebetween, wherein: the front edges of the plurality of side panels of the first seating element and the front edges of the plurality of side panels of the second seating element are opposed to each other; the generally planar panel rests on the bumpers of the first and second seating elements, the bumpers together configured to support a weight of the generally planar panel; and the generally planar panel is sized to span a distance between the cosmetic panels coupled to the front edge of each of the plurality of side panels of the two seating elements, thereby defining the substantially coplanar surface with the cosmetic panels coupled to the upper edge of the plurality of side panels of each of the two seating elements.

A seventh aspect may include any of the second through sixth aspects, wherein each of the plurality of side panels comprises first and second panel faces extending generally between the front and rear edges and the upper and lower edges, the first and second panel faces defining a thickness of the plurality of side panels; each of the plurality of side panels comprises a plurality of vertical ribs and a plurality of horizontal ribs extending perpendicular to the first and second panel faces of the plurality of side panels; at least some of the plurality of vertical ribs are positioned adjacent the front edge and the rear edge of each of the plurality of side panels; at least some of the plurality of horizontal ribs are positioned adjacent the upper edge and the lower edge of each of the plurality of side panels; and the said some of the plurality of vertical ribs and the said some of the plurality of horizontal ribs are connected, such that the said some of the plurality of vertical and horizontal ribs define an external ridge of each of the plurality of side panels.

An eighth aspect may include the seventh aspect, and wherein each of the plurality of side panels comprises an opening positioned inboard in the side panels from the rear edge, the front edge, the upper edge, and the lower edge; and the opening defines an inboard rear edge opposed to the rear edge and adjacent the opening, an inboard front edge opposed to the front edge and adjacent the opening, an inboard upper edge opposed to the upper edge and adjacent the opening, and an inboard lower edge opposed to the lower edge and adjacent the opening.

A ninth aspect may include any of the second through eighth aspects, and wherein each of the plurality of generally planar side panels further comprises: first and second panel faces extending generally between the front and rear edges and the upper and lower edges, the first and second panel faces defining a thickness of the plurality of generally planar side panels; and a plurality of mounting apertures extending from the first panel face to the second panel face.

A tenth aspect may include any of the second through ninth aspects, and wherein the seating element further comprises a plurality of aperture reinforcements, each aperture reinforcement comprising: an aperture reinforcement rear edge; an aperture reinforcement front edge; an aperture reinforcement lower edge; an aperture reinforcement upper edge; and an aperture reinforcement first face and an aperture reinforcement second face extending generally between the front and rear edges and the upper and lower edges, the aperture reinforcement first and second faces defining a thickness of the aperture reinforcement, wherein the aperture reinforcement second face is adjacent to one of the first and second panel faces of the side panel, and each of the aperture reinforcements are anchored to one of the mounting apertures of one of the side panels.

An eleventh aspect may include the tenth aspect, and wherein each aperture reinforcement is anchored to a respective mounting aperture via at least one snap fitting protruding from the aperture reinforcement second face of each of the plurality of aperture reinforcements.

A twelfth aspect may include the eleventh aspect, and wherein each of the plurality of aperture reinforcements comprises a secondary guide hole extending through the aperture reinforcement first and second faces; and the secondary guide hole of the aperture reinforcement corresponds to one of a plurality of primary guide holes of the plurality of side panels when the aperture reinforcement is anchored to one of the plurality of mounting apertures.

A thirteenth aspect may include the twelfth aspect, wherein the seating element further comprises: a plurality of cosmetic panels coupled to at least one of the rear edge, the front edge, the upper edge, the lower edge, the first panel face, or the second panel face of at least one of the plurality of side panels; and a plurality of fasteners each extending from the side panel to the aperture reinforcement and through to one of the plurality of cosmetic panels, thereby coupling the one of the plurality of cosmetic panels to the side panel.

A fourteenth aspect may include any of the second through thirteenth aspects, and may further comprise a cabinet structure in contact with one of the upstanding walls, the cabinet structure comprising a plurality of generally planar side panels, each of the plurality of side panels comprising: a rear edge adjacent one of the upstanding walls; a front edge distal to one of the upstanding walls; a lower edge; an upper edge distal to the floor; first and second panel faces extending generally between the front and rear edges and the upper and lower edges, the first and second panel faces defining a thickness of the plurality of generally planar side panels; and a plurality of mounting apertures extending from the first panel face to the second panel face.

A fifteenth aspect may include any previous aspect, and may further comprise a seating element in contact with the horizontal floor, the seating element comprising at least one tubular support and a plurality of generally planar side panels each comprising a rear edge, a front edge, a lower edge adjacent the horizontal floor, an upper edge distal to the floor, and first and second panel faces extending generally between the front and rear edges and the upper and lower edges and defining a thickness of the side panel, wherein: each of the side panels comprises a plurality of channels extending between the first and second side panel faces, the seating element further comprises a plurality of tubular supports, each tubular support extends from the channel of one of the plurality of side panels to a corresponding channel of another of the plurality of side panels, and the plurality of tubular supports interconnect the plurality of sides panels, thereby providing rigidity to the seating element.

A sixteenth aspect may include the fifteenth aspect, wherein each of the plurality of side panels further comprises: a plurality of mounting apertures extending from the first panel face to the second panel face; and a plurality of aperture reinforcements, each aperture reinforcement comprising: an aperture reinforcement rear edge, an aperture reinforcement front edge, an aperture reinforcement lower edge, an aperture reinforcement upper edge, and an aperture reinforcement first face and an aperture reinforcement second face extending generally between the front and rear edges and the upper and lower edges, the aperture reinforcement first and second faces defining a thickness of the aperture reinforcements, wherein: the aperture reinforcement second face is adjacent to one of the first and second panel faces of the side panel; each of the aperture reinforcements are anchored to one of the mounting apertures of one of the sub-panels; and each aperture reinforcement is anchored to a respective mounting aperture via at least one snap fitting protruding from the aperture reinforcement second face of each of the plurality of aperture reinforcements.

A seventeenth aspect may include any previous aspect, and may alternatively or additionally include a cabinet structure in contact with one of the upstanding walls, the cabinet structure comprising a plurality of generally planar side panels, each of the plurality of side panels comprising: a rear edge adjacent one of the upstanding walls, a front edge distal to one of the upstanding walls, a lower edge, an upper edge distal to the floor, first and second panel faces extending generally between the front and rear edges and the upper and lower edges, a plurality of interconnected vertical ribs and horizontal ribs extending from the first and second panel faces, the ribs defining, within each of the plurality of side panels, first and second lateral sections extending in a lateral direction, first and second vertical sections extending in a vertical direction, and four corner sections interposed between the vertical and lateral sections, and an opening extending between the first and second side panel faces and positioned inboard to the front edge, the rear edge, the upper edge, and the lower edge of each of the side panels, thereby separating the first lateral section from the second lateral sections in the vertical direction and separating the first vertical section from the second vertical section in the lateral direction, and wherein: the first lateral section defines a first base shelf offset dimension BSO₁ in the vertical direction and the second lateral section defines a second base shelf offset dimension BSO₂ in the vertical direction; the first and second base shelf offset dimensions are dissimilar to each other; and each of the lateral sections and each of the vertical sections comprise a plurality of mounting apertures.

An eighteenth aspect may include the seventeenth aspect, and wherein the first vertical section defines a third base shelf offset dimension BSO₃ in the lateral direction; the second vertical section defines a fourth base shelf offset dimension BSO₄ in the lateral direction; and the third and fourth base shelf offset dimensions are dissimilar to each other.

A nineteenth aspect may include either the seventeenth or eighteenth aspects, wherein the plurality of vertical and horizontal ribs define, in at least one of the plurality of side panels, first, second, third, and fourth inboard corner sections disposed interior of the first and second lateral sections and the first and second vertical sections in the side panel; the first inboard corner section is disposed proximate the first vertical section and the first lateral section; the second inboard corner section is disposed proximate the second vertical section and the first lateral section; the third inboard corner section is disposed proximate the first vertical section and the second lateral section; the fourth inboard corner section is disposed proximate the second vertical section and the second lateral section; the first and third inboard corner sections define a first shelving offset dimension SO₁ in the lateral direction; the second and fourth lateral sections define a second shelving offset dimension SO₂ in the lateral direction; the first and second shelving offset dimensions are dissimilar to each other; and each of the plurality of inboard corner sections comprise the plurality of mounting apertures.

A twentieth aspect may include any of the seventeenth through nineteenth aspects, and wherein the cabinet structure comprises a first plurality of the side panels and a second plurality of the side panels; one of the first plurality of the side panels is mounted to one of the second plurality of the side panels; the cabinet structure comprises a bridge section comprising a transition from the first plurality of the side panels to the second plurality of the side panels; the upper edge of the first plurality of the side panels is generally planar with the upper edge of the second plurality of the side panels; the lower edge of the first plurality of the side panels is not generally planar with the lower edge of the second plurality of the side panels; and a height from the upper edge to the lower edge of the first plurality of side panels is greater than a height from the upper edge to the lower edge of the second plurality of side panels.

A twenty-first aspect may include the twentieth aspect, and wherein the cabinet structure comprises a third plurality of the side panels; the bridge section comprises a second transition from the second plurality of the side panels to the third plurality of the side panels; one of the third plurality of the side panels is mounted to one of the second plurality of the side panels; the upper edge of the second plurality of the side panels is generally planar with the upper edge of the third plurality of the side panels; the lower edge of the second plurality of the side panels is not generally planar with the lower edge of the third plurality of the side panels; and a height from the upper edge to the lower edge of the third plurality of side panels is greater than a height from the upper edge to the lower edge of the second plurality of side panels.

A twenty-second aspect may include any of the seventeenth through twenty-first aspects, and wherein each of the side panels comprises a plurality of channels extending between the first and second side panel faces; the cabinet structure further comprises a plurality of tubular supports; each tubular support extends from the channel of one of the plurality of side panels to a corresponding channel of another of the plurality of side panels; and the plurality of tubular supports interconnect the plurality of sides panels, thereby providing rigidity to the cabinet structure.

A twenty-third aspect may include the twenty-second aspect, and wherein the cabinet structure further comprises a plurality of spacers mounted on the one or more tubular supports, each of the spacers comprising: an insert comprising opposite insert walls and a tubular support mounting face for receiving the tubular support in the spacer and mounting the spacer on the tubular support, the tubular support mounting face defining a transition between the opposite insert walls; a primary orientation mounting face; a secondary orientation mounting face; a transition face defining a transition between the primary mounting face and the secondary mounting face; a primary orientation backing face opposite the primary orientation mounting face and defining a transition between one of the insert walls and the secondary mounting face; and a secondary orientation backing face opposite the second orientation mounting face and defining a transition between the other of the insert walls and the primary mounting face.

A twenty-fourth aspect may include the twenty-third aspect, and wherein at least some of the spacers are mounted in a primary orientation on the plurality of tubular supports, at least some of the spacers are mounted in a secondary orientation on the plurality of tubular supports, or both; the primary orientation of the spacer on the tubular support is defined by the secondary mounting face being proximate the top and distal the floor and the secondary mounting backing face being proximate the floor and distal the top; the secondary orientation of the spacer on the tubular support is defined by the primary mounting face being proximate the top and distal the floor and the primary mounting backing face being proximate the floor and distal the top; and a height H₁ of the spacer from the primary orientation mounting face to the primary orientation backing face is less than a height H₂ from the secondary orientation mounting face to the secondary orientation backing face.

A twenty-fifth aspect may include any of the seventeenth through twenty-fourth aspects, and wherein the seating element further comprises a plurality of aperture reinforcements, each aperture reinforcement comprising: an aperture reinforcement rear edge; an aperture reinforcement front edge; an aperture reinforcement lower edge; an aperture reinforcement upper edge; and an aperture reinforcement first face and an aperture reinforcement second face extending generally between the front and rear edges and the upper and lower edges, the aperture reinforcement first and second faces defining a thickness of the plurality of aperture reinforcements, wherein the aperture reinforcement second face is adjacent to one of the first and second panel faces of the side panel, and each of the aperture reinforcements are anchored to one of the mounting apertures of one of the sub-panels.

A twenty-sixth aspect may include the twenty-fifth aspect, and wherein each aperture reinforcement is anchored to a respective mounting aperture via at least one snap fitting protruding from the aperture reinforcement second face of each of the plurality of aperture reinforcements.

A twenty-seventh aspect may include the twenty-sixth aspect, and wherein each of the plurality of aperture reinforcements comprises a guide hole extending through the aperture reinforcement first and second faces; and the guide hole of the aperture reinforcement corresponds to one of a plurality of guide holes of the plurality of side panels when the aperture reinforcement is anchored to one of the plurality of mounting apertures.

A twenty-eighth aspect may include any of the seventeenth through twenty-seventh aspects, and wherein the cabinet further comprises a plurality of cosmetic panels coupled to at least one of the rear edge, the front edge, the upper edge, the lower edge, the first panel face, or the second panel face of at least one of the plurality of side panels; and a plurality of fasteners each extending through one of the aperture reinforcements from the aperture reinforcement second face through to one of the plurality of cosmetic panels, thereby coupling the one of the plurality of cosmetic panels to the side panel.

A twenty-ninth aspect may include any previous aspect, and may further comprise a cabinet structure in contact with one of the upstanding walls, the cabinet structure comprising a plurality of tubular supports and a plurality of generally planar side panels, each of the plurality of side panels comprising a rear edge adjacent one of the upstanding walls, a front edge distal to one of the upstanding walls, a lower edge, an upper edge distal to the floor, first and second panel faces extending generally between the front and rear edges and the upper and lower edges, and a plurality of channels extending between the first and second side panel faces, and wherein each tubular support extends from the channel of one of the plurality of side panels to a corresponding channel of another of the plurality of side panels; and the plurality of tubular supports interconnect the plurality of sides panels, thereby providing rigidity to the cabinet structure.

A thirtieth aspect may include the twenty-ninth aspect, wherein the cabinet structure further comprises a plurality of spacers mounted on the one or more tubular supports, each of the spacers comprising: an insert comprising opposite insert walls and a tubular support mounting face for receiving the tubular support in the spacer and mounting the spacer on the tubular support, the tubular support mounting face defining a transition between the opposite insert walls; a primary orientation mounting face; a secondary orientation mounting face; a transition face defining a transition between the primary mounting face and the secondary mounting face; a primary orientation backing face opposite the primary orientation mounting face and defining a transition between one of the insert walls and the secondary mounting face; and a secondary orientation backing face opposite the second orientation mounting face and defining a transition between the other of the insert walls and the primary mounting face.

A thirty-first aspect may include the thirtieth aspect, and wherein at least some of the spacers are mounted in a primary orientation on the plurality of tubular supports, at least some of the spacers are mounted in a secondary orientation on the plurality of tubular supports, or both; the primary orientation of the spacer on the tubular support is defined by the secondary mounting face being proximate the top and distal the floor and the secondary mounting backing face being proximate the floor and distal the top; the secondary orientation of the spacer on the tubular support is defined by the primary mounting face being proximate the top and distal the floor and the primary mounting backing face being proximate the floor and distal the top; and a height H₁ of the spacer from the primary orientation mounting face to the primary orientation backing face is less than a height H₂ from the secondary orientation mounting face to the secondary orientation backing face.

It is noted that recitations in the present disclosure of a component of the present disclosure being “configured”, “operable”, or “sufficient” in a particular way, to embody a particular property, or to function in a particular manner, are structural recitations, as opposed to recitations of intended use. More specifically, the references in the present disclosure to the manner in which a component is “configured”, “operable”, or “sufficient” denotes an existing physical condition of the component and, as such, is to be taken as a definite recitation of the structural characteristics of the component.

It is also noted that recitations herein of “at least one” component, element, etc., should not be used to create an inference that the alternative use of the articles “a” or “an” should be limited to a single component, element, etc. The singular forms “a,” “an” and “the” include plural referents, unless the context clearly dictates otherwise.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.” It is noted that the use of the terms “having” or “including”, or grammatical variations thereof, in this disclosure should also be interpreted in like manner as the more commonly used open-ended preamble term “comprising”.

As used in this disclosure, terms such as “first” and “second” are arbitrarily assigned and are merely intended to differentiate between two or more instances or components. It is to be understood that the words “first” and “second” serve no other purpose and are not part of the name or description of the component, nor do they necessarily define a relative location, position, or order of the component. Furthermore, it is to be understood that the mere use of the term “first” and “second” does not require that there be any “third” component, although that possibility is contemplated under the scope of the present disclosure.

Having described the subject matter of the present embodiments herein in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description.

Further, it will be apparent that modifications and variations are possible without departing from the scope of the present embodiments including, but not limited to, embodiments defined in the appended claims. More specifically, although some aspects of the present embodiments are identified herein as preferred or particularly advantageous, it is contemplated that the present embodiments is not necessarily limited to these aspects.

What is claimed is:

1. A recreational vehicle of the type comprising a living space, the recreational vehicle comprising:
a generally horizontal floor;
a vehicle body comprising a plurality of generally upstanding walls defining the living space in conjunction with the generally horizontal floor, each of the plurality of generally upstanding walls comprising a bottom adjacent the floor and a top distal to the floor; and
a seating element in contact with the horizontal floor, the seating element comprising a plurality of tubular supports and a plurality of generally planar side panels each comprising a rear edge, a front edge, a lower edge adjacent the horizontal floor, and an upper edge distal to the floor, and wherein:
the upper edge of each of the plurality of side panels comprises a first ledge adjacent the front edge and a second ledge proximal the rear edge of each of the plurality of side panels, the ledges being closer to the lower edge than a remainder of the upper edge is to the lower edge,
each of tubular supports extends from one of the ledges of one of the plurality of side panels to a corresponding ledge of another of the plurality of side panels, and
the ledges are configured such that an upper surface of the tubular supports positioned in the ledges are coplanar with the remainder of the upper edge.

2. The recreational vehicle of claim 1, wherein:
a first portion of the remainder of the upper edge is positioned between the first and second ledges;
a second portion of the remainder of the upper edge is positioned between the second ledge and the rear edge of each of the plurality of side panels; and
the second portion of the remainder of the upper edge defines the backing of the seating element.

3. The recreational vehicle of claim 1, wherein the seating element comprises a cosmetic panel positioned on:
a portion of the remainder of the upper edge positioned between the first and second ledges; and
the tubular supports disposed on the first and second ledges of each of the plurality of side panels, thereby:
obscuring the portion of the remainder of the upper edge positioned between the first and second ledges and the tubular supports disposed on the first and second ledges of each of the plurality of side panels, and
defining a substantially coplanar surface.

4. The recreational vehicle of claim 3, wherein the seating element comprises:
an additional cosmetic panel coupled to the front edge of each of the plurality of side panels; and
a plurality of bumpers coupled to the additional cosmetic panel coupled to the front edge of each of the plurality of side panels.

5. The recreational vehicle of claim 4, further comprising two of the seating elements and a generally planar panel positioned therebetween, wherein:
the front edges of the plurality of side panels of the first seating element and the front edges of the plurality of side panels of the second seating element are opposed to each other;
the generally planar panel rests on the bumpers of the first and second seating elements, the bumpers together configured to support a weight of the generally planar panel; and
the generally planar panel is sized to span a distance between the cosmetic panels coupled to the front edge of each of the plurality of side panels of the two seating elements, thereby defining the substantially coplanar surface with the cosmetic panels coupled to the upper edge of the plurality of side panels of each of the two seating elements.

6. The recreational vehicle of claim 1, wherein:
each of the plurality of side panels comprises first and second panel faces extending generally between the front and rear edges and the upper and lower edges, the first and second panel faces defining a thickness of the plurality of side panels;
each of the plurality of side panels comprises a plurality of vertical ribs and a plurality of horizontal ribs extending perpendicular to the first and second panel faces of the plurality of side panels;
at least some of the plurality of vertical ribs are positioned adjacent the front edge and the rear edge of each of the plurality of side panels;
at least some of the plurality of horizontal ribs are positioned adjacent the upper edge and the lower edge of each of the plurality of side panels; and
the said some of the plurality of vertical ribs and the said some of the plurality of horizontal ribs are connected, such that the said some of the plurality of vertical and horizontal ribs define an external ridge of each of the plurality of side panels.

7. The recreational vehicle of claim 6, wherein:
each of the plurality of side panels comprises an opening positioned inboard in the side panels from the rear edge, the front edge, the upper edge, and the lower edge; and
the opening defines an inboard rear edge opposed to the rear edge and adjacent the opening, an inboard front edge opposed to the front edge and adjacent the opening, an inboard upper edge opposed to the upper edge and adjacent the opening, and an inboard lower edge opposed to the lower edge and adjacent the opening.

8. The recreational vehicle of claim 1, wherein each of the plurality of generally planar side panels further comprises:
first and second panel faces extending generally between the front and rear edges and the upper and lower edges, the first and second panel faces defining a thickness of the plurality of generally planar side panels; and
a plurality of mounting apertures extending from the first panel face to the second panel face.

9. The recreational vehicle of claim 8, wherein the seating element further comprises a plurality of aperture reinforcements, each aperture reinforcement comprising:
an aperture reinforcement rear edge;
an aperture reinforcement front edge;
an aperture reinforcement lower edge;
an aperture reinforcement upper edge; and
an aperture reinforcement first face and an aperture reinforcement second face extending generally between the front and rear edges and the upper and lower edges, the aperture reinforcement first and second faces defining a thickness of the aperture reinforcement, wherein
the aperture reinforcement second face is adjacent to one of the first and second panel faces of the side panel, and
each of the aperture reinforcements are anchored to one of the mounting apertures of one of the side panels.

10. The recreational vehicle of claim 9, wherein each aperture reinforcement is anchored to a respective mounting aperture via at least one snap fitting protruding from the aperture reinforcement second face of each of the plurality of aperture reinforcements.

11. The recreational vehicle of claim 10, wherein:
each of the plurality of aperture reinforcements comprises a secondary guide hole extending through the aperture reinforcement first and second faces; and
the secondary guide hole of the aperture reinforcement corresponds to one of a plurality of primary guide holes of the plurality of side panels when the aperture reinforcement is anchored to one of the plurality of mounting apertures.

12. The recreational vehicle of claim 11, wherein the seating element further comprises:
a plurality of cosmetic panels coupled to at least one of the rear edge, the front edge, the upper edge, the lower edge, the first panel face, or the second panel face of at least one of the plurality of side panels; and
a plurality of fasteners each extending from the side panel to the aperture reinforcement and through to one of the plurality of cosmetic panels, thereby coupling the one of the plurality of cosmetic panels to the side panel.

13. The recreational vehicle of claim 1, further comprising a cabinet structure in contact with one of the upstanding walls, the cabinet structure comprising a plurality of generally planar side panels, each of the plurality of side panels comprising:
a rear edge adjacent one of the upstanding walls;
a front edge distal to one of the upstanding walls;
a lower edge;
an upper edge distal to the floor;
first and second panel faces extending generally between the front and rear edges and the upper and lower edges, the first and second panel faces defining a thickness of the plurality of generally planar side panels; and
a plurality of mounting apertures extending from the first panel face to the second panel face.

14. A recreational vehicle of the type comprising a living space, the recreational vehicle comprising:
a generally horizontal floor;
a vehicle body comprising a plurality of generally upstanding walls defining the living space in conjunction with the generally horizontal floor, each of the plurality of generally upstanding walls comprising a bottom adjacent the floor and a top distal to the floor; and
a seating element in contact with the horizontal floor, the seating element comprising at least one tubular support and a plurality of generally planar side panels each comprising a rear edge, a front edge, a lower edge adjacent the horizontal floor, an upper edge distal to the floor, and first and second panel faces extending generally between the front and rear edges and the upper and lower edges and defining a thickness of the side panel, wherein:
each of the side panels comprises a plurality of channels extending between the first and second side panel faces,
the seating element further comprises a plurality of tubular supports,
each tubular support extends from the channel of one of the plurality of side panels to a corresponding channel of another of the plurality of side panels, and
the plurality of tubular supports interconnect the plurality of sides panels, thereby providing rigidity to the seating element.

15. The recreational vehicle of claim 14, wherein each of the plurality of side panels further comprises:
a plurality of mounting apertures extending from the first panel face to the second panel face; and
a plurality of aperture reinforcements, each aperture reinforcement comprising:
an aperture reinforcement rear edge,
an aperture reinforcement front edge,
an aperture reinforcement lower edge,
an aperture reinforcement upper edge, and
an aperture reinforcement first face and an aperture reinforcement second face extending generally between the front and rear edges and the upper and lower edges, the aperture reinforcement first and second faces defining a thickness of the aperture reinforcements, wherein:
the aperture reinforcement second face is adjacent to one of the first and second panel faces of the side panel;
each of the aperture reinforcements are anchored to one of the mounting apertures of one of the sub-panels; and
each aperture reinforcement is anchored to a respective mounting aperture via at least one snap fitting protruding from the aperture reinforcement second face of each of the plurality of aperture reinforcements.

16. The recreational vehicle of claim 14, wherein:
each of the plurality of side panels comprises first and second panel faces extending generally between the front and rear edges and the upper and lower edges, the first and second panel faces defining a thickness of the plurality of side panels;
each of the plurality of side panels comprises a plurality of vertical ribs and a plurality of horizontal ribs extending perpendicular to the first and second panel faces of the plurality of side panels;
at least some of the plurality of vertical ribs are positioned adjacent the front edge and the rear edge of each of the plurality of side panels;
at least some of the plurality of horizontal ribs are positioned adjacent the upper edge and the lower edge of each of the plurality of side panels; and
the said some of the plurality of vertical ribs and the said some of the plurality of horizontal ribs are connected, such that the said some of the plurality of vertical and horizontal ribs define an external ridge of each of the plurality of side panels.

17. The recreational vehicle of claim 16, wherein:
each of the plurality of side panels comprises an opening positioned inboard in the side panels from the rear edge, the front edge, the upper edge, and the lower edge; and
the opening defines an inboard rear edge opposed to the rear edge and adjacent the opening, an inboard front edge opposed to the front edge and adjacent the opening, an inboard upper edge opposed to the upper edge and adjacent the opening, and an inboard lower edge opposed to the lower edge and adjacent the opening.

18. The recreational vehicle of claim 14, wherein:
each of the plurality of generally planar side panels further comprises first and second panel faces extending generally between the front and rear edges and the upper and lower edges, the first and second panel faces defining a thickness of the plurality of generally planar side panels; and a plurality of mounting apertures extending from the first panel face to the second panel face;
the seating element further comprises a plurality of aperture reinforcements, each aperture reinforcement comprising an aperture reinforcement rear edge; an aperture reinforcement front edge; an aperture reinforcement lower edge; an aperture reinforcement upper edge; and an aperture reinforcement first face and an aperture reinforcement second face extending generally between the front and rear edges and the upper and lower edges;
the aperture reinforcement first and second faces define a thickness of the aperture reinforcement;
the aperture reinforcement second face is adjacent to one of the first and second panel faces of the side panel;
each of the aperture reinforcements are anchored to one of the mounting apertures of one of the side panels; and
each aperture reinforcement is anchored to a respective mounting aperture via at least one snap fitting protruding from the aperture reinforcement second face of each of the plurality of aperture reinforcements.

19. The recreational vehicle of claim 18, wherein:
each of the plurality of aperture reinforcements comprises a secondary guide hole extending through the aperture reinforcement first and second faces;
the secondary guide hole of the aperture reinforcement corresponds to one of a plurality of primary guide holes of the plurality of side panels when the aperture reinforcement is anchored to one of the plurality of mounting apertures; and
the seating element further comprises a plurality of cosmetic panels coupled to at least one of the rear edge, the front edge, the upper edge, the lower edge, the first panel face, or the second panel face of at least one of the plurality of side panels; and a plurality of fasteners each extending from the side panel to the aperture reinforcement and through to one of the plurality of cosmetic panels, thereby coupling the one of the plurality of cosmetic panels to the side panel.

20. The recreational vehicle of claim 14, further comprising a cabinet structure in contact with one of the upstanding walls, the cabinet structure comprising a plurality of generally planar side panels, each of the plurality of side panels comprising:
a rear edge adjacent one of the upstanding walls;
a front edge distal to one of the upstanding walls;
a lower edge;
an upper edge distal to the floor;
first and second panel faces extending generally between the front and rear edges and the upper and lower edges, the first and second panel faces defining a thickness of the plurality of generally planar side panels; and
a plurality of mounting apertures extending from the first panel face to the second panel face.
